(19) United States
(12) Patent Application Publication
(10) Pub. No.: US 2016/0236148 A1
(43) Pub. Date: Aug. 18, 2016

(54) ZONED CATALYTIC CONVERTERS FOR GASOLINE ENGINES WITH REDUCED RHODIUM CONTENT

(71) Applicant: SDCmaterials, Inc., Tempe, AZ (US)

(72) Inventors: Qinghua YIN, Tempe, AZ (US); Xiwang QI, Scottsdale, AZ (US); Bryant KEARL, Phoenix, AZ (US); Maximilian A. BIBERGER, Scottsdale, AZ (US)

(21) Appl. No.: 15/042,960

(22) Filed: Feb. 12, 2016

Related U.S. Application Data
(60) Provisional application No. 62/116,275, filed on Feb. 13, 2015.
(60) Provisional application No. 62/118,991, filed on Feb. 20, 2015.
(60) Provisional application No. 62/133,837, filed on Mar. 16, 2015.
(60) Provisional application No. 62/116,233, filed on Feb. 13, 2015.

(51) Int. Cl. B01D 53/94; B01J 23/10; F01N 3/10; B01J 21/04; B01J 35/00; B01J 37/02; B01J 23/44; B01J 23/02

(52) U.S. Cl. CPC B01D 53/945; B01J 23/44; B01J 23/10; B01J 23/02; B01J 21/04; B01J 35/0013; B01J 37/0244; F01N 3/101; B01D 2255/9032; B01D 2255/40; B01D 2255/908; B01D 2255/1023; B01D 2255/2065; B01D 2255/2092; B01D 2255/2042

(57) ABSTRACT

Zoned substrates and catalytic converters comprising zoned substrates for use in treating exhaust gases from gasoline engines are disclosed, along with materials for use in providing high oxygen storage capacity for the catalytic converters. Methods of making the zoned substrates, catalytic converters, and the oxygen storage material are also disclosed.

### CROSS-REFERENCE TO RELATED APPLICATIONS

This application claims priority benefit of U.S. Provisional Patent Application No. 62/116,275, filed Feb. 13, 2015; of U.S. Provisional Patent Application No. 62/118,991, filed Feb. 20, 2015; of U.S. Provisional Patent Application No. 62/133,837, filed Mar. 16, 2015; and of U.S. Provisional Patent Application No. 62/116,233, filed Feb. 13, 2015. The entire contents of all of those applications are incorporated by reference herein.

### FIELD OF THE INVENTION

The invention relates to catalytic converters used to treat gasoline engine exhaust, and materials used to provide oxygen storage capacity in catalytic converters, such as three-way catalytic converters used to treat gasoline engine exhaust.

### BACKGROUND OF THE INVENTION

Gasoline and diesel internal combustion engine exhaust contains various pollutants, including carbon monoxide (CO), unburned hydrocarbons due to incomplete combustion (“HC”), and nitrogen oxides (such as NO and NO₂). Abatement of such pollutants is desirable from an environmental standpoint, and is mandated by law in many countries. Catalytic converters which can reduce the amounts of these gases in engine exhaust were developed in response to such regulatory requirements.

Catalytic converters for gasoline engines are called “three-way” catalytic converters as they oxide CO to CO₂, oxidize unburned hydrocarbons to CO₂, and reduce nitrogen oxides to N₂. Gasoline engines are typically tuned so that the mixture of fuel and air is very close to the stoichiometric ratio required for complete combustion of hydrocarbons and oxygen to carbon dioxide and water. Running in a fuel-lean condition, with excess oxygen over the stoichiometric ratio, is desirable for complete combustion of hydrocarbons (reducing CO and unburned hydrocarbon output), while running in a fuel-rich condition, with excess hydrocarbon fuel over the stoichiometric ratio, is desirable for optimal conditions for reduction of nitrogen oxides to nitrogen by the catalytic converter. Accordingly, gasoline engines are usually tuned to oscillate within a narrow air-fuel ratio band, running slightly richer to provide a mixture of gases to the catalytic converter suitable to reduce nitrogen oxides, then running slightly leaner to provide a mixture of gases to the catalytic converter suitable to oxidize hydrocarbons and carbon monoxide.

During the part of the cycle when nitrogen oxides are reduced, the catalytic converter must still oxidize hydrocarbons and carbon monoxide. There is little oxygen present in the catalytic converter gases during that part of the cycle. In order to supply oxygen for the oxidization of hydrocarbons and carbon monoxide during the richer part of the cycle, materials are included on the catalytic converter which store oxygen during the leaner part of the cycle (when more oxygen is present in the gases in the catalytic converter), and which release the oxygen during the richer part of the cycle. Thus, the three-way catalytic converter has an oxygen storage capacity (OSC), which is determined by the type and amount of materials used to store oxygen during the leaner part of the cycle and release oxygen during the richer part of the cycle. Sufficient oxygen storage capacity is required in order to be able to maintain rich conditions for an appropriate amount of time to allow reduction of nitrogen oxides.

Improved oxygen storage materials for use in catalytic converters are disclosed herein and in co-owned U.S. Patent Application No. 62/116,233, filed Feb. 13, 2015, the entire disclosure of which is hereby incorporated by reference herein. The use of improved oxygen storage materials on coated substrates, and in catalytic converters for gasoline engines, is described herein.

Platinum group metals, such as platinum, palladium, and rhodium, are commonly used in catalytic converters. Rhodium is often used for catalytic reduction of nitrogen oxides to nitrogen and oxygen in gasoline catalytic converters. Rhodium has been subject to dramatic price swings, from nearly US$10,000 per ounce in June 2008 to about US$1,000 per ounce in December 2008. Accordingly, it is also desirable to minimize the use of rhodium (as well as minimizing the use of other platinum group metals, which are also expensive and subject to rapid price fluctuation).

### BRIEF SUMMARY OF THE INVENTION

Embodiments of the invention provide for coated substrates; methods of making coated substrates; catalytic converters comprising a coated substrate as described herein; methods of treating exhaust gases, such as the exhaust gases from a gasoline engine, with coated substrates or catalytic converters as described herein; and vehicles comprising a coated substrate or catalytic converter as described herein. The coated substrates and catalytic converters described herein have reduced requirements for rhodium as a reduction catalyst, or do not require rhodium as a reduction catalyst, which results in savings in materials costs and fabrication costs of the catalytic converters. The coated substrates described herein can be used as three-way catalysts. The catalytic converters described herein can be used as three-way catalytic converters.

Various embodiments of the invention are described herein. The features of each of the embodiments are combinable with any of the other embodiments where appropriate and practical.

In some embodiments, the invention provides a coated substrate for use in a catalytic converter for treatment of gasoline engine exhaust. The coated substrate comprises a substrate; a first washcoat layer disposed in a first zone of the substrate, the first washcoat layer comprising first composite nanoparticles comprising a first catalytic nanoparticle bonded to a first support nanoparticle; and first metal oxide particles impregnated with barium oxide; and a second washcoat layer disposed in a second zone of the substrate, the second washcoat layer comprising second composite nanoparticles comprising a second catalytic nanoparticle bonded to a second support nanoparticle; and oxygen storage particles. In some embodiments, the first composite nanoparticles are covalently bound to the first metal oxide particles impregnated with barium oxide. In some embodiments, the first composite nanoparticles are calcined onto the first metal oxide particles impregnated with barium oxide. In some embodiments, including any of the foregoing and following embodiments, the first zone and second zone on the substrate do not overlap.

In some embodiments of the coated substrate, the first catalytic nanoparticle of the first composite nanoparticles comprises palladium. In some embodiments, the first support nanoparticle of the first composite nanoparticles comprises aluminum oxide. In some embodiments, the first catalytic nanoparticle of the first composite nanoparticles comprises palladium and the first support nanoparticle of the first composite nanoparticles comprises aluminum oxide.

In some embodiments of the coated substrate, the first metal oxide particles comprise a metal oxide selected from the group consisting of cerium oxide, cerium-zirconium oxide, cerium-zirconium-lanthanum oxide, cerium-zirconium-yttrium oxide, and cerium-zirconium-lanthanum-yttrium oxide, said first metal oxide particles further impregnated with barium oxide. In some embodiments, the first metal oxide particles comprise cerium-zirconium-lanthanum oxide, said cerium-zirconium-lanthanum oxide further impregnated with barium oxide. In some embodiments, the first catalytic nanoparticle of the first composite nanoparticles comprises palladium, the first support nanoparticle of the first composite nanoparticles comprises aluminum oxide, and the first metal oxide particles comprise cerium-zirconium-lanthanum oxide, said cerium-zirconium-lanthanum oxide further impregnated with barium oxide.

In some embodiments of the coated substrate, the second catalytic nanoparticle of the second composite nanoparticles comprises palladium. In some embodiments, the second support nanoparticle of the second composite nanoparticles comprises a metal oxide selected from the group consisting of cerium oxide, cerium-zirconium oxide, cerium-zirconium-lanthanum oxide, cerium-zirconium-yttrium oxide, and cerium-zirconium-lanthanum-yttrium oxide. In some embodiments, the second support nanoparticle of the second composite nanoparticles comprises cerium oxide. In some embodiments, the second catalytic nanoparticle of the second composite nanoparticles comprises palladium, and the second support nanoparticle of the second composite nanoparticles comprises cerium oxide.

In some embodiments of the coated substrate, the oxygen storage material particles comprise a second metal oxide impregnated with a third metal oxide. In some embodiments, the second metal oxide comprises a material selected from the group consisting of aluminum oxide and aluminum oxide stabilized with lanthanum. In some embodiments, the third metal oxide comprises a material selected from the group consisting of cerium oxide, cerium-zirconium oxide, cerium-zirconium-lanthanum oxide, cerium-zirconium-yttrium oxide, and cerium-zirconium-lanthanum-yttrium oxide. In some embodiments, the second metal oxide comprises aluminum oxide stabilized with lanthanum, and the third metal oxide comprises cerium oxide. In some embodiments, the second catalytic nanoparticle of the second composite nanoparticles comprises palladium, the second support nanoparticle of the second composite nanoparticles comprises cerium oxide, the second metal oxide comprises aluminum oxide stabilized with lanthanum, and the third metal oxide comprises cerium oxide.

In some embodiments of the coated substrate, the oxygen storage material particles further comprise rhodium metal. In some alternative embodiments of the coated substrate, the coated substrate is free of rhodium or substantially free of rhodium.

In some embodiments of the coated substrate, the first metal oxide particles are between about 500 nm and about 10 microns in diameter. In some embodiments, the oxygen storage particles are between about 500 nm and about 10 microns in diameter. In some embodiments, the first metal oxide particles are between about 500 nm and about 10 microns in diameter, and the oxygen storage particles are between about 500 nm and about 10 microns in diameter.

In any of the embodiments of the coated substrate described herein, the substrate can comprise a cordierite substrate. In any of the embodiments described herein, the substrate can comprise a metallic substrate.

In any of the embodiments of the coated substrate described herein, the substrate can be free of, or substantially free of, platinum.

In some embodiments, the invention provides a coated substrate for use in a catalytic converter for treatment of gasoline engine exhaust. The coated substrate comprises a substrate; a first washcoat layer disposed in a first zone of the substrate, the first washcoat layer comprising first composite nanoparticles comprising a first catalytic nanoparticle bonded to a first support nanoparticle; first metal oxide particles; and barium oxide; and a second washcoat layer disposed in a second zone of the substrate, the second washcoat layer comprising second composite nanoparticles comprising a second catalytic nanoparticle bonded to a second support nanoparticle; and oxygen storage particles In some embodiments, the second composite nanoparticles are covalently bound to the oxygen storage particles. In some embodiments, the second composite nanoparticles are calcined onto the oxygen storage particles. In some embodiments, including any of the foregoing and following embodiments, the first zone and second zone on the substrate do not overlap.

In some embodiments, the first catalytic nanoparticle of the first composite nanoparticles comprises palladium. In some embodiments, the first support nanoparticle of the first composite nanoparticles comprises aluminum oxide. In some embodiments, the first catalytic nanoparticle of the first composite nanoparticles comprises palladium and the first support nanoparticle of the first composite nanoparticles comprises aluminum oxide.

In some embodiments of the coated substrate, the first metal oxide particles comprise a metal oxide selected from the group consisting of cerium oxide, cerium-zirconium oxide, cerium-zirconium-lanthanum oxide, cerium-zirconium-yttrium oxide, and cerium-zirconium-lanthanum-yttrium oxide. In some embodiments, the first metal oxide particles comprise cerium-zirconium-lanthanum oxide. In some embodiments, the first catalytic nanoparticle of the first composite nanoparticles comprises palladium, the first support nanoparticle of the first composite nanoparticles comprises aluminum oxide, and the first metal oxide particles comprise cerium-zirconium-lanthanum oxide.

In some embodiments of the coated substrate, the second catalytic nanoparticle of the second composite nanoparticles comprises palladium. In some embodiments, the second support nanoparticle of the second composite nanoparticles comprises a metal oxide selected from the group consisting of cerium oxide, cerium-zirconium oxide, cerium-zirconium-lanthanum oxide, cerium-zirconium-yttrium oxide, and cerium-zirconium-lanthanum-yttrium oxide. In some embodiments, the second support nanoparticle of the second composite nanoparticles comprises cerium oxide. In some embodiments, the second catalytic nanoparticle of the second composite nanoparticles comprises palladium, and the second support nanoparticle of the second composite nanoparticles comprises cerium oxide.

In some embodiments of the coated substrate, the oxygen storage material particles comprise a second metal oxide impregnated with a third metal oxide. In some embodiments, the second metal oxide comprises a material selected from the group consisting of aluminum oxide and aluminum oxide stabilized with lanthanum. In some embodiments, the third metal oxide comprises a material selected from the group consisting of cerium oxide, cerium-zirconium oxide, cerium-zirconium-lanthanum oxide, cerium-zirconium-yttrium oxide, and cerium-zirconium-lanthanum-yttrium oxide. In some embodiments, the second metal oxide comprises aluminum oxide stabilized with lanthanum, and the third metal oxide comprises cerium oxide. In some embodiments, the second catalytic nanoparticle of the second composite nanoparticles comprises palladium, the second support nanoparticle of the second composite nanoparticles comprises cerium oxide, the second metal oxide comprises aluminum oxide stabilized with lanthanum, and the third metal oxide comprises cerium oxide.

In some embodiments of the coated substrate, the oxygen storage material particles further comprise rhodium metal. In some alternative embodiments of the coated substrate, the coated substrate is free of rhodium or substantially free of rhodium.

In some embodiments of the coated substrate, the first metal oxide particles are between about 500 nm and about 10 microns in diameter. In some embodiments, the oxygen storage particles are between about 500 nm and about 10 microns in diameter. In some embodiments, the first metal oxide particles are between about 500 nm and about 10 microns in diameter, and the oxygen storage particles are between about 500 nm and about 10 microns in diameter.

In any of the embodiments of the coated substrate described herein, the substrate can comprise a cordierite substrate. In any of the embodiments described herein, the substrate can comprise a metallic substrate.

In any of the embodiments of the coated substrate described herein, the substrate can be free of, or substantially free of, platinum.

In some embodiments, the invention provides a method of making a coated substrate for use in a catalytic converter for treatment of gasoline engine exhaust. The method comprises coating a substrate with a first washcoat formulation in a first zone of the substrate, the first washcoat formulation comprising first composite nanoparticles comprising a first catalytic nanoparticle bonded to a first support nanoparticle; and first metal oxide particles impregnated with barium oxide; and coating the substrate with a second washcoat formulation in a second zone of the substrate, the second washcoat formulation comprising second composite nanoparticles comprising a second catalytic nanoparticle bonded to a second support nanoparticle; and oxygen storage particles. In some embodiments, the first zone and second zone on the substrate do not overlap.

In some embodiments of the method of making a coated substrate, the first catalytic nanoparticle of the first composite nanoparticles comprises palladium. In some embodiments, the first support nanoparticle of the first composite nanoparticles comprises aluminum oxide. In some embodiments, the first catalytic nanoparticle of the first composite nanoparticles comprises palladium and the first support nanoparticle of the first composite nanoparticles comprises aluminum oxide.

In some embodiments of the method of making a coated substrate, the first metal oxide particles comprise a metal oxide selected from the group consisting of cerium oxide, cerium-zirconium oxide, cerium-zirconium-lanthanum oxide, cerium-zirconium-yttrium oxide, and cerium-zirconium-lanthanum-yttrium oxide, said first metal oxide particles further impregnated with barium oxide. In some embodiments, the first metal oxide particles comprise cerium-zirconium-lanthanum oxide, said cerium-zirconium-lanthanum oxide further impregnated with barium oxide. In some embodiments, the first catalytic nanoparticle of the first composite nanoparticles comprises palladium, the first support nanoparticle of the first composite nanoparticles comprises aluminum oxide, and the first metal oxide particles comprise cerium-zirconium-lanthanum oxide, said cerium-zirconium-lanthanum oxide further impregnated with barium oxide.

In some embodiments of the method of making a coated substrate, the second catalytic nanoparticle of the second composite nanoparticles comprises palladium. In some embodiments, the second support nanoparticle of the second composite nanoparticles comprises a metal oxide selected from the group consisting of cerium oxide, cerium-zirconium oxide, cerium-zirconium-lanthanum oxide, cerium-zirconium-yttrium oxide, and cerium-zirconium-lanthanum-yttrium oxide. In some embodiments, the second support nanoparticle of the second composite nanoparticles comprises cerium oxide. In some embodiments, the second catalytic nanoparticle of the second composite nanoparticles comprises palladium, and the second support nanoparticle of the second composite nanoparticles comprises cerium oxide.

In some embodiments of the method of making a coated substrate, the oxygen storage material particles comprise a second metal oxide impregnated with a third metal oxide. In some embodiments, the second metal oxide comprises a material selected from the group consisting of aluminum oxide and aluminum oxide stabilized with lanthanum. In some embodiments, the third metal oxide comprises a material selected from the group consisting of cerium oxide, cerium-zirconium oxide, cerium-zirconium-lanthanum oxide, cerium-zirconium-yttrium oxide, and cerium-zirconium-lanthanum-yttrium oxide. In some embodiments, the second metal oxide comprises aluminum oxide stabilized with lanthanum, and the third metal oxide comprises cerium oxide. In some embodiments, the second catalytic nanoparticle of the second composite nanoparticles comprises palladium, the second support nanoparticle of the second composite nanoparticles comprises cerium oxide, the second metal oxide comprises aluminum oxide stabilized with lanthanum, and the third metal oxide comprises cerium oxide.

In some embodiments of the method of making a coated substrate, the first metal oxide particles are between about 500 nm and about 10 microns in diameter. In some embodiments, the oxygen storage particles are between about 500 nm and about 10 microns in diameter. In some embodiments, the first metal oxide particles are between about 500 nm and about 10 microns in diameter, and the oxygen storage particles are between about 500 nm and about 10 microns in diameter.

In any of the embodiments of the method of making a coated substrate described herein, prior to coating the substrate with the first washcoat formulation in the first zone of the substrate, the first composite nanoparticles can be impregnated into the first metal oxide particles impregnated with barium oxide, such as, for example, by impregnating an aqueous dispersion of the first composite nanoparticles into the first metal oxide particles until the point of incipient wetness, and then calcining the first metal oxide particles (which are now impregnated with both barium oxide and first composite nanoparticles). The calcining procedure forms covalent bonds between the first composite nanoparticles and the first metal oxide particles impregnated with barium oxide.

In any of the embodiments of the method of making a coated substrate described herein, prior to coating the substrate with the second washcoat formulation in the second zone of the substrate, the second composite nanoparticles can be impregnated into the oxygen storage particles, such as, for example, by impregnating an aqueous dispersion of the second composite nanoparticles into the oxygen storage particles until the point of incipient wetness, and then calcining the oxygen storage particles (which are now impregnated with both an oxygen storage component, such as cerium oxide, and second composite nanoparticles). The calcining procedure forms covalent bonds between the second composite nanoparticles and the oxygen storage particles.

In any of the embodiments of the method of making a coated substrate described herein, the first washcoat formulation can further comprise boehmite. In any of the embodiments of the method of making a coated substrate described herein, the second washcoat formulation can further comprise boehmite.

In some embodiments of the method of making a coated substrate, the oxygen storage material particles further comprise rhodium metal. In some alternative embodiments of the coated substrate, the coated substrate is free of rhodium or substantially free of rhodium. In embodiments where the oxygen storage material particles further comprise rhodium metal, the rhodium metal can be impregnated via wet chemistry methods using a solution of a rhodium salt, such as rhodium trichloride, rhodium trichloride hydrate, rhodium acetate, or rhodium nitrate, followed by drying and calcining of the oxygen storage particles, and, if necessary, reductive treatment of the oxygen storage particles to reduce the rhodium ions to rhodium metal.

In any of the embodiments of the method of making a coated substrate described herein, the substrate can comprise a cordierite substrate. In any of the embodiments described herein, the substrate can comprise a metallic substrate.

In any of the embodiments of the method of making a coated substrate described herein, the substrate can be free of, or substantially free of, platinum.

In some embodiments, the invention provides a method of making a coated substrate for use in a catalytic converter for treatment of gasoline engine exhaust. The method comprises coating a substrate with a first washcoat formulation in a first zone of the substrate, the first washcoat formulation comprising first composite nanoparticles comprising a first catalytic nanoparticle bonded to a first support nanoparticle, first metal oxide particles, and a barium oxide precursor; and coating the substrate with a second washcoat formulation in a second zone of the substrate, the second washcoat formulation comprising second composite nanoparticles comprising a second catalytic nanoparticle bonded to a second support nanoparticle, and oxygen storage particles. In some embodiments, the first zone and second zone on the substrate do not overlap.

In some embodiments of the method of making a coated substrate, the first catalytic nanoparticle of the first composite nanoparticles comprises palladium. In some embodiments, the first support nanoparticle of the first composite nanoparticles comprises aluminum oxide. In some embodiments, the first catalytic nanoparticle of the first composite nanoparticles comprises palladium and the first support nanoparticle of the first composite nanoparticles comprises aluminum oxide.

In some embodiments of the method of making a coated substrate, the first metal oxide particles comprise a metal oxide selected from the group consisting of cerium oxide, cerium-zirconium oxide, cerium-zirconium-lanthanum oxide, cerium-zirconium-yttrium oxide, and cerium-zirconium-lanthanum-yttrium oxide. In some embodiments, the first metal oxide particles comprise cerium-zirconium-lanthanum oxide. In some embodiments, the first catalytic nanoparticle of the first composite nanoparticles comprises palladium, the first support nanoparticle of the first composite nanoparticles comprises aluminum oxide, and the first metal oxide particles comprise cerium-zirconium-lanthanum oxide.

In some embodiments of the method of making a coated substrate, the second catalytic nanoparticle of the second composite nanoparticles comprises palladium. In some embodiments, the second support nanoparticle of the second composite nanoparticles comprises a metal oxide selected from the group consisting of cerium oxide, cerium-zirconium oxide, cerium-zirconium-lanthanum oxide, cerium-zirconium-yttrium oxide, and cerium-zirconium-lanthanum-yttrium oxide. In some embodiments, the second support nanoparticle of the second composite nanoparticles comprises cerium oxide. In some embodiments, the second catalytic nanoparticle of the second composite nanoparticles comprises palladium, and the second support nanoparticle of the second composite nanoparticles comprises cerium oxide.

In some embodiments of the method of making a coated substrate, the oxygen storage material particles comprise a second metal oxide impregnated with a third metal oxide. In some embodiments, the second metal oxide comprises a material selected from the group consisting of aluminum oxide and aluminum oxide stabilized with lanthanum. In some embodiments, the third metal oxide comprises a material selected from the group consisting of cerium oxide, cerium-zirconium oxide, cerium-zirconium-lanthanum oxide, cerium-zirconium-yttrium oxide, and cerium-zirconium-lanthanum-yttrium oxide. In some embodiments, the second metal oxide comprises aluminum oxide stabilized with lanthanum, and the third metal oxide comprises cerium oxide. In some embodiments, the second catalytic nanoparticle of the second composite nanoparticles comprises palladium, the second support nanoparticle of the second composite nanoparticles comprises cerium oxide, the second metal oxide comprises aluminum oxide stabilized with lanthanum, and the third metal oxide comprises cerium oxide.

In some embodiments of the method of making a coated substrate, the first metal oxide particles are between about 500 nm and about 10 microns in diameter. In some embodiments, the oxygen storage particles are between about 500 nm and about 10 microns in diameter. In some embodiments, the first metal oxide particles are between about 500 nm and about 10 microns in diameter, and the oxygen storage particles are between about 500 nm and about 10 microns in diameter.

In any of the embodiments of the method of making a coated substrate described herein, prior to coating the substrate with the second washcoat formulation in the second zone of the substrate, the second composite nanoparticles can be impregnated into the oxygen storage particles, such as, for example, by impregnating an aqueous dispersion of the second composite nanoparticles into the oxygen storage particles until the point of incipient wetness, and then calcining the oxygen storage particles (which are now impregnated with both an oxygen storage component, such as cerium oxide, and second composite nanoparticles). The calcining procedure forms covalent bonds between the second composite nanoparticles and the oxygen storage particles.

In any of the embodiments of the method of making a coated substrate described herein, the first washcoat formulation can further comprise boehmite. In any of the embodiments of the method of making a coated substrate described herein, the second washcoat formulation can further comprise boehmite.

In any of the embodiments of the method of making a coated substrate described herein, the first washcoat formulation can further comprise boehmite. In any of the embodiments of the method of making a coated substrate described herein, the second washcoat formulation can further comprise boehmite.

In some embodiments of the method of making a coated substrate, the oxygen storage material particles further comprise rhodium metal. In some alternative embodiments of the coated substrate, the coated substrate is free of rhodium or substantially free of rhodium. In embodiments where the oxygen storage material particles further comprise rhodium metal, the rhodium metal can be impregnated via wet chemistry methods using a solution of a rhodium salt, such as rhodium trichloride, rhodium trichloride hydrate, rhodium acetate, or rhodium nitrate, followed by drying and calcining of the oxygen storage particles, and, if necessary, reductive treatment of the oxygen storage particles to reduce the rhodium ions to rhodium metal.

In any of the embodiments of the method of making a coated substrate described herein, the substrate can comprise a cordierite substrate. In any of the embodiments described herein, the substrate can comprise a metallic substrate.

In any of the embodiments of the method of making a coated substrate described herein, the substrate can be free of, or substantially free of, platinum.

In some embodiments, the invention provides a coated substrate prepared by any one of the methods described herein.

In some embodiments, the invention provides a catalytic converter comprising any of the coated substrates described herein.

In some embodiments, the invention provides a method of treating exhaust gases from a gasoline engine with the coated substrates, comprising contacting the substrate with the exhaust gases. The exhaust and substrate are configured such that the exhaust from the gasoline engine contacts the first zone of the coated substrate prior to contacting the second zone of the substrate.

In some embodiments, the invention provides a method of treating exhaust gases from a gasoline engine with the catalytic converters described herein, comprising passing the exhaust gases through the catalytic converter. The exhaust and catalytic converter are configured such that the exhaust from the gasoline engine contacts the first zone of the coated substrate in the catalytic converter prior to contacting the second zone of the coated substrate in the catalytic converter.

In any of the above embodiments, the ratio of the length of the first zone to the length of the second zone can vary between about 3:1 to about 1:3, such as between about 2:1 to about 1:2. In any of the above embodiments, the length of the first zone on the coated substrate can be equal to, or about equal to, the length of the second zone on the coated substrate (that is, the first and second zones each occupy about half of the length of the coated substrate, with a small gap between them of, for example, about 5 mm to about 30 mm, or as described herein).

In some embodiments, the invention provides a vehicle comprising the coated substrates or catalytic converters described herein.

The oxygen storage particles used on any of the various coated substrates, or used in any of the various washcoats, washcoat layers, washcoat formulations, catalytic converters, or exhaust (emissions) treatment systems as described herein, can comprise any of the oxygen storage materials as described herein; or can comprise commercially obtained oxygen storage material; or can comprise a mixture of any of the oxygen storage materials as described herein and commercially obtained oxygen storage material.

In further embodiments, the invention provides materials useful as oxygen storage materials, and methods of making such oxygen storage materials. The oxygen storage materials can be used in substrate washcoats in catalytic converters for treatment of gases produced during combustion, such as treatment of gases produced by an internal combustion engine, for example, a gasoline engine. The oxygen storage materials can be used in any of the washcoats and washcoat formulations disclosed herein. The oxygen storage particles disclosed herein in on any of the various coated substrates, or used in any of the various washcoats, washcoat layers, washcoat formulations, catalytic converters, or exhaust (emissions) treatment systems as described herein, can comprise the oxygen storage materials as described herein.

In a further embodiment, the invention embraces a method of making an oxygen storage material, where the oxygen storage material comprises a first metal oxide impregnated in support particles, and where the support particles comprise a second metal oxide. The method comprises combining an aqueous solution of a precursor to the first metal oxide with the second metal oxide support particles; and converting the precursor of the first metal oxide into the first metal oxide to form the oxygen storage material. In some embodiments, the precursor of the first metal oxide is converted into the first metal oxide by calcining the particles. In some embodiments, the particles are dried after the aqueous solution is combined with the support particles, and prior to calcining. In some embodiments, the calcining is performed at a temperature between about 400° C. and about 700° C. and for a time between about 30 minutes and about 12 hours. The first metal oxide can comprise a single metallic element; or the first metal oxide can comprise multiple metallic elements, that is, the first metal oxide can be a mixed metal oxide. The second metal oxide can comprise a single metallic element; or the second metal oxide can comprise multiple metallic elements, that is, the second metal oxide can be a mixed metal oxide.

In some embodiments of the method, the first metal oxide is selected from the group consisting of cerium oxide, cerium-zirconium oxide, cerium-zirconium-lanthanum oxide, cerium-zirconium-yttrium oxide, and cerium-zirconium-lanthanum-yttrium oxide. In some embodiments, the cerium oxide content of the first metal oxide is at least 40% by weight. In some embodiments, the first metal oxide is cerium oxide. In some embodiments, the second metal oxide is selected from the group consisting of aluminum oxide and aluminum oxide stabilized with lanthanum; in some embodiments, the second metal oxide comprises aluminum oxide stabilized with lanthanum. In some embodiments, the first metal oxide comprises cerium oxide and the second metal oxide comprises aluminum oxide stabilized with lanthanum.

In some embodiments of the method, the first metal oxide is cerium oxide, and the precursor to the cerium oxide is selected from the group consisting of cerium chloride, cerium chloride heptahydrate, cerium carbonate, cerium nitrate, cerium ammonium nitrate, and cerium acetate. In some embodiments, the precursor to the cerium oxide is cerium chloride heptahydrate.

In some embodiments of the method, the final amount of the first metal oxide impregnated in the second metal oxide support particles is between about 15% to about 45% of the weight of the second metal oxide support particles prior to impregnation.

The invention further embraces an oxygen storage material prepared by any of the methods disclosed herein.

In some embodiments, the invention embraces an oxygen storage material comprising a first metal oxide impregnated in support particles comprising a second metal oxide. The first metal oxide can comprise a single metallic element; or the first metal oxide can comprise multiple metallic elements, that is, the first metal oxide can be a mixed metal oxide. In some embodiments, the first metal oxide can be selected from the group consisting of cerium oxide, cerium-zirconium oxide, cerium-zirconium-lanthanum oxide, cerium-zirconium-yttrium oxide, and cerium-zirconium-lanthanum-yttrium oxide. In some embodiments, the first metal oxide comprises cerium oxide. The second metal oxide can comprise a single metallic element; or the second metal oxide can comprise multiple metallic elements, that is, the second metal oxide can be a mixed metal oxide. In some embodiments, the second metal oxide can be selected from the group consisting of aluminum oxide and aluminum oxide stabilized with lanthanum. In some embodiments, the second metal oxide comprises aluminum oxide stabilized with lanthanum. In some embodiments, the first metal oxide can be selected from the group consisting of cerium oxide, cerium-zirconium oxide, cerium-zirconium-lanthanum oxide, cerium-zirconium-yttrium oxide, and cerium-zirconium-lanthanum-yttrium oxide, and the second metal oxide is selected from the group consisting of aluminum oxide and aluminum oxide stabilized with lanthanum. In some embodiments, the first metal oxide comprises cerium oxide and the second metal oxide comprises aluminum oxide stabilized with lanthanum.

In some embodiments of the oxygen storage material, the cerium oxide content of the first metal oxide is at least 40% by weight.

In some embodiments of the oxygen storage material, the final amount of the first metal oxide impregnated in the second metal oxide support particles is between about 15% to about 45% of the weight of the second metal oxide support particles prior to impregnation.

### BRIEF DESCRIPTION OF THE DRAWINGS

FIG. 1 illustrates a catalytic converter in accordance with some embodiments of the present invention, while FIG. 1A is a magnified view of a portion of the drawing of FIG. 1.

FIG. 2 shows a schematic illustration of a zoned catalytic converter in accordance with some embodiments of the present invention.

### DETAILED DESCRIPTION OF THE INVENTION

### Definitions

When numerical values are expressed herein using the term “about” or the term “approximately,” it is understood that both the value specified, as well as values reasonably close to the value specified, are included. For example, the description “about 50° C.” or “approximately 50° C.” includes both the disclosure of 50° C. itself, as well as values close to 50° C. Thus, the phrases “about X” or “approximately X” include a description of the value X itself. If a range is indicated, such as “approximately 50° C. to 60° C.,” it is understood that both the values specified by the endpoints are included, and that values close to each endpoint or both endpoints are included for each endpoint or both endpoints; that is, “approximately 50° C. to 60° C.” is equivalent to reciting both “50° C. to 60° C.” and “approximately 50° C. to approximately 60° C.”

As used herein, the term “embedded” when describing nanoparticles embedded in a porous carrier includes the term “bridged together by” when describing nanoparticles bridged together by a porous carrier, and refers to the configuration of the nanoparticles in the porous carrier resulting when the porous carrier is formed around or surrounds the nanoparticles, generally by using the methods described herein. That is, the resulting structure contains nanoparticles with a scaffolding of porous carrier between the nanoparticles, for example built up around or surrounding the nanoparticles. The porous carrier encompasses the nanoparticles, while at the same time, by virtue of its porosity, the porous carrier permits external gases to contact the embedded nanoparticles. Nanoparticles “embedded” within a porous carrier may include a configuration wherein nanoparticles are connected together (i.e., bridged together) by a carrier material.

It is generally understood by one of skill in the art that the unit of measure g/L,” “g/l,” or “grams per liter” is used as a measure of density of a substance in terms of the mass of the substance in any given volume containing that substance. In some embodiments, the “g/l” or g/L is used to refer to the loading density of a substance into, for example, a coated substrate. For example, in some embodiments, “4.0 g/L platinum” may refer to the loading of 4.0 grams of platinum into each liter of a coated substrate. Similarly, in some embodiments, “30 g/L metal oxide” may refer to the loading of 30 grams of a metal oxide into each liter of a coated substrate.

The terms “micro-particle,” “micro-sized particle,” “micron-particle,” and “micron-sized particle” are generally understood to encompass a particle on the order of micrometers in diameter, typically between about 0.5 μm to 1000 μm, about 1 μm to 1000 μm, about 1 μm to 100 μm, or about 1 μm to 50 μm. Additionally, the term “platinum group metals” (abbreviated “PGM”) used in this disclosure refers to the collective name used for six metallic elements clustered together in the periodic table. The six platinum group metals are ruthenium, rhodium, palladium, osmium, iridium, and platinum.

A “portion” of a material is understood to mean at least some of the material and, in some embodiments, may include all of that material. In some embodiments, a “portion” of a material may include more than 0% of the material, more than about 10% of the material, more than about 20% of the material, more than about 30% of the material, more than about 40% of the material, more than about 50% of the material, more than about 60% of the material, more than about 70% of the material, more than about 80% of the material, or more than about 90% of the material. In some embodiments, a “portion” of a material may include a range from more than 0% to about 10%, a range from more than 0% to about 20%, a range from more than 0% to about 30%, a range from more than 0% to about 40%, a range from more than 0% to about 50%, a range from more than 0% to about 60%, a range from more than 0% to about 70%, a range from more than 0% to about 80%, a range from more than 0% to about 90%, or a range from more than 0% to about 100% of the material.

This disclosure refers to both particles and powders. These two terms are equivalent, except for the caveat that a singular “powder” refers to a collection of particles. The present invention can apply to a wide variety of powders and particles. The terms “nanoparticle” and “nano-sized particle” are generally understood by those of ordinary skill in the art to encompass a particle on the order of nanometers in diameter, typically between about 0.5 nm to 500 nm, about 1 nm to 500 nm, about 1 nm to 100 nm, or about 1 nm to 50 nm. Preferably, the nanoparticles have an average grain size less than 250 nanometers and an aspect ratio between one and one million. In some embodiments, the nanoparticles have an average grain size of about 50 nm or less, about 30 nm or less, or about 20 nm or less. In additional embodiments, the nanoparticles have an average diameter of about 50 nm or less, about 30 nm or less, or about 20 nm or less. The aspect ratio of the particles, defined as the longest dimension of the particle divided by the shortest dimension of the particle, is preferably between one and one hundred, more preferably between one and ten, yet more preferably between one and two. “Grain size” is measured using the ASTM (American Society for Testing and Materials) standard (see ASTM E112-10). When calculating a diameter of a particle, the average of its longest and shortest dimension is taken; thus, the diameter of an ovoid particle with long axis 20 nm and short axis 10 nm would be 15 nm. The average diameter of a population of particles is the average of diameters of the individual particles, and can be measured by various techniques known to those of skill in the art.

By “substantially free of” a specific component, a specific composition, a specific compound, or a specific ingredient in various embodiments, is meant that less than about 5%, less than about 2%, less than about 1%, less than about 0.5%, less than about 0.1%, less than about 0.05%, less than about 0.025%, or less than about 0.01% of the specific component, the specific composition, the specific compound, or the specific ingredient is present by weight. Preferably, “substantially free of” a specific component, a specific composition, a specific compound, or a specific ingredient indicates that less than about 1% of the specific component, the specific composition, the specific compound, or the specific ingredient is present by weight.

It should be noted that, during fabrication or during operation (particularly over long periods of time), small amounts of materials present in one washcoat layer may diffuse, migrate, or otherwise move into other washcoat layers. Accordingly, use of the terms “substantial absence of” and “substantially free of” is not to be construed as absolutely excluding minor amounts of the materials referenced.

By “substantially each” of a specific component, a specific composition, a specific compound, or a specific ingredient in various embodiments, is meant that at least about 95%, at least about 98%, at least about 99%, at least about 99.5%, at least about 99.9%, at least about 99.95%, at least about 99.975%, or at least about 99.99% of the specific component, the specific composition, the specific compound, or the specific ingredient is present by number or by weight. Preferably, “substantially each” of a specific component, a specific composition, a specific compound, or a specific ingredient is meant that at least about 99% of the specific component, the specific composition, the specific compound, or the specific ingredient is present by number or by weight.

It is understood that reference to relative weight percentages in a composition assumes that the combined total weight percentages of all components in the composition add up to 100. It is further understood that relative weight percentages of one or more components may be adjusted upwards or downwards such that the weight percent of the components in the composition combine to a total of 100, provided that the weight percent of any particular component does not fall outside the limits of the range specified for that component.

The term “washcoat composition” as used herein may be used to refer to a washcoat slurry or a washcoat layer. A washcoat slurry may comprise solids or salts suspended or dissolved in a liquid. The washcoat slurry may be coated onto a substrate, dried, and calcined. A “washcoat layer” generally refers to a washcoat composition after the composition has been applied to a substrate, dried, and calcined.

The term “reduced rhodium content” refers to a reduction in the amount of rhodium used, that is, it refers to the thrifting of rhodium compared to a reference coated substrate or reference catalytic converter.

Metal oxides can comprise a single metallic element combined with oxygen, such as cerium oxide (ceria), zirconium oxide (zirconia), or aluminum oxide (alumina). Metal oxides can comprise two or more metallic elements combined with oxygen, such as cerium-zirconium oxide (CeZrO₄), cerium-zirconium-lanthanum oxide, cerium-zirconium-yttrium oxide, cerium-zirconium-lanthanum-yttrium oxide, or aluminum oxide (alumina) stabilized with lanthanum. Metal oxides which comprise two or more metallic elements combined with oxygen can be referred to as mixed metal oxides.

Various aspects of the disclosure can be described through the use of flowcharts. Often, a single instance of an aspect of the present disclosure is shown. As is appreciated by those of ordinary skill in the art, however, the protocols, processes, and procedures described herein can be repeated continuously or as often as necessary to satisfy the needs described herein. In addition, it is contemplated that certain method steps can be performed in alternative sequences to those disclosed in the flowcharts.

This disclosure provides several embodiments. It is contemplated that any features from any embodiment can be combined with any features from any other embodiment. In this fashion, hybrid configurations of the disclosed features are within the scope of the present invention.

### Use of Coated Substrates of the Invention in Catalytic Converters

The coated substrates of the invention can be used in catalytic converters for treatment of the exhaust gases of combustion engines. They are particularly useful for treatment of the exhaust from gasoline engines. Catalytic converters for gasoline engines must oxidize unburned hydrocarbons to carbon dioxide and water, oxidize carbon monoxide to carbon dioxide, and reduce oxides of nitrogen (NOx) to nitrogen and oxygen. Rhodium is generally used as a reduction catalyst in catalytic converters for gasoline exhaust. Palladium, platinum, or a mixture of palladium and platinum can be used as the oxidation catalyst. Platinum tends to be much more expensive than palladium, and accordingly, it is preferable to minimize the amount of platinum used as an oxidation catalyst. In one embodiment, the coated substrates and/or catalytic converters disclosed herein are free of platinum or substantially free of platinum. In one embodiment, the coated substrates and/or catalytic converters disclosed herein use only palladium as an oxidation catalyst.

The coated substrates and/or catalytic converters of the invention can be rhodium-free as discussed herein; however, rhodium can be added for certain applications or conditions when desired. Thus, in some embodiments, the coated substrates and/or catalytic converters are free of rhodium or substantially free of rhodium. In other embodiments, the zone-coated substrates and/or catalytic converters using zone-coated substrates disclosed herein have a reduced rhodium content compared to coated substrates which are not zoned and/or which lack composite nanoparticles and/or which lack high oxygen storage capacity material, and/or catalytic converters using coated substrates which are not zoned and/or which lack composite nanoparticles and/or which lack high oxygen storage capacity material, while the zone-coated substrates and/or catalytic converters using zone-coated substrates with reduced rhodium content disclosed herein maintain the same, about the same, at least the same, or at least about the same pollution-reduction performance as compared to coated substrates which are not zoned and/or which lack composite nanoparticles and/or which lack high oxygen storage capacity material, and/or catalytic converters using coated substrates which are not zoned and/or which lack composite nanoparticles and/or which lack high oxygen storage capacity material.

In some embodiments, the zone-coated substrates and/or catalytic converters using zone-coated substrates disclosed herein can have a reduced rhodium content of at least about 10%, at least about 20%, at least about 25%, at least about 30%, at least about 40%, at least about 50%, at least about 60%, at least about 70%, at least about 75%, at least about 80%, at least about 90%, at least about 95%, or at least about 99% as compared to coated substrates which are not zoned and/or which lack composite nanoparticles, and/or catalytic converters using coated substrates which are not zoned and/or which lack composite nanoparticles and/or which lack high oxygen storage capacity material, and where the zone-coated substrates and/or catalytic converters using zone-coated substrates with reduced rhodium content disclosed herein maintain the same, about the same, at least the same, or at least about the same pollution-reduction performance as compared to coated substrates which are not zoned and/or which lack composite nanoparticles, and/or catalytic converters using coated substrates which are not zoned and/or which lack composite nanoparticles and/or which lack high oxygen storage capacity material.

In some embodiments, the zone-coated substrates and/or catalytic converters using zone-coated substrates disclosed herein can have a reduced rhodium content of about 10% to about 80%, about 20% to about 80%, about 30% to about 80%, about 40% to about 80%, about 50% to about 80%, about 60% to about 80%, about 10% to about 95%, about 20% to about 95%, about 30% to about 95%, about 40% to about 95%, about 50% to about 95%, about 60% to about 95%, about 70% to about 95%, about 80% to about 95%, about 10% to about 99%, about 20% to about 99%, about 30% to about 99%, about 40% to about 99%, about 50% to about 99%, about 60% to about 99%, about 70% to about 99%, or about 80% to about 99%, as compared to coated substrates which are not zoned and/or which lack composite nanoparticles and/or which lack high oxygen storage capacity material, and/or catalytic converters using coated substrates which are not zoned and/or which lack composite nanoparticles and/or which lack high oxygen storage capacity material, and where the zone-coated substrates and/or catalytic converters using zone-coated substrates with reduced rhodium content disclosed herein maintain the same, about the same, at least the same, or at least about the same pollution-reduction performance as compared to coated substrates which are not zoned and/or which lack composite nanoparticles and/or which lack high oxygen storage capacity material, and/or catalytic converters using coated substrates which are not zoned and/or which lack composite nanoparticles and/or which lack high oxygen storage capacity material.

In some embodiments, the zone-coated substrates and/or catalytic converters using zone-coated substrates disclosed herein can have a reduced rhodium content of about 10% to about 30%, about 20% to about 40%, about 30% to about 50%, about 40% to about 60%, about 50% to about 70%, about 60% to about 80%, about 70% to about 90%, about 75% to about 95%, or about 75% to about 99%, as compared to coated substrates which are not zoned and/or which lack composite nanoparticles and/or which lack high oxygen storage capacity material, and/or catalytic converters using coated substrates which are not zoned and/or which lack composite nanoparticles and/or which lack high oxygen storage capacity material, and where the zone-coated substrates and/or catalytic converters using zone-coated substrates with reduced rhodium content disclosed herein maintain the same, about the same, at least the same, or at least about the same pollution-reduction performance as compared to coated substrates which are not zoned and/or which lack composite nanoparticles and/or which lack high oxygen storage capacity material, and/or catalytic converters using coated substrates which are not zoned and/or which lack composite nanoparticles and/or which lack high oxygen storage capacity material.

When rhodium is used, it is added in an amount from about 0.01 g/L to about 0.6 g/L, or from about 0.01 g/L to about 0.5 g/L, or from about 0.01 g/L to about 0.4 g/L, or from about 0.01 g/L to about 0.3 g/L, or from about 0.01 g/L to about 0.2 g/L, or from about 0.01 g/L to about 0.1 g/L, or from about 0.05 g/L to about 0.6 g/L, or from about 0.05 g/L to about 0.5 g/L, or from about 0.05 g/L to about 0.4 g/L, or from about 0.05 g/L to about 0.3 g/L, or from about 0.05 g/L to about 0.2 g/L, or from about 0.05 g/L to about 0.1 g/L, or from about 0.1 g/L to about 0.6 g/L, or from about 0.1 g/L to about 0.5 g/L, or from about 0.1 g/L to about 0.4 g/L, or from about 0.1 g/L to about 0.3 g/L, or from about 0.1 g/L to about 0.2 g/L, or from about 0.15 g/L to about 0.45 g/L, or from about 0.2 g/L to about 0.4 g/L, or from about 0.25 g/L to about 0.35 g/L, or about 0.3 g/L; the amounts given are for when the length of the second zone is roughly equal to the length of the first zone (i.e., the second zone occupies roughly half of the substrate). In other embodiments when rhodium is used, it is added in an amount of no more than about 0.6 g/L, or no more than about 0.5 g/L, or no more than about 0.4 g/L, or no more than about 0.3 g/L, or no more than about 0.2 g/L, or no more than about 0.1 g/L, or no more than about 0.05 g/L, or no more than about 0.01 g/L; the amounts given are for when the length of the second zone is roughly equal to the length of the first zone (i.e., the second zone occupies roughly half of the substrate). A typical loading of rhodium in the second zone of the substrate is about 0.25 g/L to about 0.35 g/L, such as about 0.3 g/L.

The rhodium-free coated substrates and catalytic converters using rhodium-free coated substrates, show optimal performance when the air-fuel weight ratio lambda, λ, is about 0.99, plus or minus 0.02; that is, lambda is between about 0.97 and 1.01. (Lambda of 1 indicates a stoichiometric air-fuel weight ratio.) Preferably, lambda is about 0.99, plus or minus 0.01; more preferably, lambda is about 0.99. Thus, the rhodium-free coated substrates work best on engines where lambda is about 0.99 and does not vary significantly. Examples of such engines are stationary gasoline engines under an approximately constant load, such as a gasoline-powered generator.

Automobile gasoline engines are generally tuned to stay close to a lambda of 1.0. The rhodium-free coated substrates and catalytic converters using rhodium-free coated substrates disclosed herein can be used on an automobile gasoline engine. However, changes in acceleration or vehicle load can cause excursions of lambda outside of the range of 0.97 to 1.01. For best pollution abatement performance, the reduced-rhodium coated substrates and catalytic converters using reduced rhodium coated substrates disclosed herein are preferred for use with gasoline engines when air-fuel weight ratios (lambda) are expected to vary outside of the range of 0.97 to 1.01.

### Components of Oxygen Storage Materials

The oxygen storage material, in one embodiment, comprises a support component and an oxygen storage component.

The support component can comprise a metal oxide, such as aluminum oxide (gamma-alumina), or aluminum oxide stabilized by lanthanum (that is, lanthanum-doped aluminum oxide, which increases the stability of high surface area gamma-aluminum oxide). The support component can be in the form of particles. The support component particles are preferably micron-sized. The support component particles can have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns. In one embodiment, the support component comprises MI-386 particles, which are lanthanum-stabilized aluminum oxide particles commercially available from Rhodia.

Prior to further use, the support component particles can be aged by heating. The particles can be aged at temperatures between about 600° C. to about 1100° C., or between about 700° C. to 1050° C., or about 800° C. to about 1000° C., or about 900° C. to about 1000° C., or at about 980° C., for times between about 2 hours and about 48 hours, between about 4 hours and about 24 hours, between about 6 hours and about 16 hours, between about 8 hours and about 12 hours, or for about 10 hours. In one embodiment, the support component particles are aged for about 10 hours at 980° C.

The oxygen storage component can comprise cerium oxide (CeO₂). Alternatively, the oxygen storage component can comprise a cerium-zirconium mixed metal oxide CeₓZr_{y}O₄, where x+y=2. In one embodiment of CeₓZr_{y}O₄, x+y=2, and x≧0.8. In another embodiment, the oxygen storage component can comprise a cerium-zirconium mixed metal oxide, where the mixed metal oxide contains at least 40% cerium oxide on a weight basis. Alternatively, the oxygen storage component can comprise a cerium-zirconium-lanthanum mixed metal oxide, a cerium-zirconium-yttrium mixed metal oxide, or a cerium-zirconium-lanthanum-yttrium mixed metal oxide. In one embodiment, the cerium-zirconium-lanthanum mixed metal oxide, cerium-zirconium-yttrium mixed metal oxide, or cerium-zirconium-lanthanum-yttrium mixed metal oxide contains at least 40% cerium oxide on a weight basis.

The oxygen storage component can be placed on or in the support component by impregnating the support component with a solution of a precursor of the oxygen storage component, followed by drying and calcination of the precursor-laden support to generate a support material loaded with an oxygen storage component. Drying of the precursor-laden support can be carried out at a temperature between room temperature and below the boiling point of water, such as between about 25° C. and about 95° C., or about 40° C. to about 80° C., or about 55° C. to about 65° C., such as about 60° C. Drying is performed until further drying results in no further weight loss of the precursor-laden support, which indicates that the aqueous solvent has been removed. Drying can be carried out for about one hour to seven days, or about two hours to about 48 hours, or about 4 hours to about 24 hours; typically, the higher the temperature, the shorter the drying period. Drying can be carried out for about 12 hours to about 20 hours at about 55° C. to about 65° C., such as for about 16 hours at about 60° C.

The size of the oxygen storage component on or in the support material can be between about 0.5 nm to about 500 nm, between about 0.5 nm to about 200 nm, between about 0.5 nm to about 100 nm, between about 0.5 nm to about 75 nm, between about 0.5 nm to about 50 nm, between about 0.5 nm to about 25 nm, between about 0.5 nm to about 20 nm, between about 1 nm to about 500 nm, between about 1 nm to about 200 nm, between about 1 nm to about 100 nm, between about 1 nm to about 75 nm, between about 1 nm to about 50 nm, between about 1 nm to about 25 nm, or between about 1 nm to about 20 nm, with the proviso that the size of the oxygen storage component cannot be larger than the size of the support material. Typically, the size of the oxygen storage component is at least about one order of magnitude or at least about two orders of magnitude smaller than the support material. When the support material comprises support particles, the oxygen storage component is typically present on the support particles in multiple deposits; the multiple deposits can be of substantially similar size, or can be of different sizes.

After drying the precursor-laden support, calcination of the support can be performed. Calcining the dried support can be performed at a temperature between about 400° C. and about 700° C., or between about 500° C. and 600° C., or between about 525° C. and 575° C., or at about 550° C. Calcining the dried support can be performed for a time between about 30 minutes and about 12 hours, or about 30 minutes and about 6 hours, or about 1 hour and about 3 hours, or about 2 hours. Calcining the dried support can be performed at a temperature of about 550° C. for about 2 hours.

Sufficient oxygen storage component precursor is impregnated into the support material such that the amount of oxygen storage component on the support material is about 10% to about 50% by weight of the original weight of the support material prior to impregnation; or about 15% to about 45% by weight of the original weight of the support material prior to impregnation; or about 20% to about 40% by weight of the original weight of the support material prior to impregnation; or about 25% to about 35% by weight of the original weight of the support material prior to impregnation. In a further embodiment, sufficient oxygen storage component precursor is impregnated into the support material such that the amount of oxygen storage component on the support material is about 30% by weight of the original weight of the support material prior to impregnation.

### Use of Oxygen Storage Material in Washcoats and Catalytic Converters

The oxygen storage materials as disclosed herein are useful in washcoat preparations and washcoat layers. Substrates, such as cordierite substrates or metal foil substrates, can be coated with washcoats containing the oxygen storage materials.

Substrates coated with washcoats using the oxygen storage materials can be used in catalytic converters for treating exhaust gases, such as the exhaust gases from internal combustion engines. The internal combustion engine can be a diesel engine or a gasoline engine. The engine may be a vehicle engine, or may be a stationary engine. The oxygen storage materials in the washcoat layers on the substrate in the catalytic converter can store oxygen during fuel-lean engine cycles, and release oxygen during fuel-rich engine cycles. Washcoat formulations in which the oxygen storage material can be used include, but are not limited to, three-way catalytic converter washcoat formulations and lean NOx trap catalytic converter washcoat formulations. Washcoat configurations in which the oxygen storage material can be used include, but are not limited to, three-way catalytic converter washcoat configurations and lean NOx trap catalytic converter washcoat configurations. Substrates in which the oxygen storage materials can be used include, but are not limited to, substrates for three-way catalytic converters and substrates for lean NOx trap catalytic converters. Catalytic converters in which the oxygen storage materials can be used include, but are not limited to, three-way catalytic converters and lean NOx trap catalytic converters.

Washcoat formulations, washcoat layers, washcoat configurations, coated substrates, and catalytic converters in which the oxygen storage materials can be used include those disclosed herein, those disclosed in US Patent Application Publication No. 2014/0140909, and those disclosed in US Patent Application Publication No. 2015/0165418. The entire contents of those applications are hereby incorporated by reference herein. The oxygen storage material can be used in a washcoat formulation, washcoat layers, washcoat configurations, coated substrates, or catalytic converters in conjunction with an oxidizing catalyst. The oxygen storage material can be used in a washcoat formulation, washcoat layers, washcoat configurations, coated substrates, or catalytic converters in conjunction with a reducing catalyst. The oxygen storage material can be used in a washcoat formulation, washcoat layers, washcoat configurations, coated substrates, or catalytic converters in conjunction with an oxidizing catalyst and a reducing catalyst.

Precursors for Impregnation into Supports for Oxygen Storage Components

Various precursors of the oxygen storage component can be used for impregnation of the support component. An aqueous solution of cerium chloride (such as cerium (III) chloride heptahydrate) can be used to impregnate support material, followed by drying and calcining of the impregnated support to generate support material loaded with cerium oxide. Other cerium oxide precursors include, but are not limited to, cerium carbonate, cerium nitrate, cerium ammonium nitrate, and cerium acetate. Additionally, any cerium salt which can be used in aqueous solution as a precursor to cerium oxide can be used. These cerium oxide precursors can be used for preparation of mixed metal oxides such as cerium-zirconium mixed metal oxide, cerium-zirconium-lanthanum mixed metal oxide, cerium-zirconium-yttrium mixed metal oxide, or cerium-zirconium-lanthanum-yttrium mixed metal oxide.

Zirconium oxide precursors which can be mixed together with the cerium oxide precursors to prepare cerium-zirconium oxide include, but are not limited to, zirconium acetate, zirconium nitrate, zirconium oxynitrate, zirconium oxychloride, ammonium zirconium carbonate, zirconium(IV) oxide 2-ethylhexanoate, zirconium (IV) acetylacetonate, zirconium citrate, and zirconium oxalate. Additionally, any zirconium salt which can be used in aqueous solution as a precursor to zirconium oxide can be used. These zirconium oxide precursors can be used for preparation of mixed metal oxides such as cerium-zirconium mixed metal oxide, cerium-zirconium-lanthanum mixed metal oxide, cerium-zirconium-yttrium mixed metal oxide, or cerium-zirconium-lanthanum-yttrium mixed metal oxide.

A lanthanum oxide precursor which can be mixed together with other metal oxide precursors to prepare cerium-zirconium-lanthanum oxide or cerium-zirconium-lanthanum-yttrium oxide includes lanthanum nitrate. Additionally, any lanthanum salt which can be used in aqueous solution as a precursor to lanthanum oxide can be used. These lanthanum oxide precursors can be used for preparation of mixed metal oxides such as cerium-zirconium-lanthanum mixed metal oxide or cerium-zirconium-lanthanum-yttrium mixed metal oxide.

A yttrium oxide precursor which can be mixed together with other metal oxide precursors to prepare cerium-zirconium-yttrium oxide or cerium-zirconium-lanthanum-yttrium oxide includes yttrium nitrate. Additionally, any yttrium salt which can be used in aqueous solution as a precursor to yttrium oxide can be used. These yttrium oxide precursors can be used for preparation of mixed metal oxides such as cerium-zirconium-yttrium mixed metal oxide or cerium-zirconium-lanthanum-yttrium mixed metal oxide.

Deionized water, distilled water, or filtered tap water can be mixed with the metal oxide precursors in order to prepare the aqueous solution of the oxygen storage component precursor. Deionized water and distilled water are preferred.

### Substrates

The initial substrate is preferably a catalytic converter substrate that demonstrates good thermal stability, including resistance to thermal shock, and to which washcoats as described herein can be affixed in a stable manner. Suitable substrates include, but are not limited to, substrates formed from cordierite or other ceramic materials, and substrates formed from metal. The substrate may be a honeycomb structure. The substrates may include a grid array structure or coiled foil structure, which provide numerous channels and result in a high surface area. The high surface area of the coated substrate with its applied washcoats in the catalytic converter provides for effective treatment of the exhaust gas flowing through the catalytic converter. A corner fill layer, or a buffer layer or adhesion layer such as a thin boehmite layer, may be applied to the substrate prior to applying any of the active washcoat layers, but is not required.

### Zoned Catalytic Converters

Zoned catalytic converters can be readily prepared by techniques known in the art, such as those described in U.S. Pat. No. 5,010,051 or U.S. Pat. No. 5,057,483. Zone coating can be accomplished simply by dipping a first end of a substrate into a first washcoat formulation, and subsequently dipping the second end of the substrate into a second washcoat formulation. Other methods of zone coating known in the art can be used.

Zone coating can be used to separate various washcoat formulations or washcoat layers into different regions on a substrate, rather than having the washcoat formulations or washcoat layers in the same region on the substrate. In other words, instead of coating a substrate with a first washcoat, and then coating the substrate with a second washcoat disposed on top of the first washcoat, the substrate can be coated in one region or zone with a first washcoat, and then in a different region or zone with another washcoat, so that the contact (or overlap) between different washcoats can be adjusted as desired, including minimizing contact or eliminating contact between different washcoats. A small gap can be left between the zones of the coated substrate, such as a gap of 5 mm or less; the gap should be as small as practical so as to maximize the use of the surface area of the substrate. In some embodiments, the gap between the different zones of the coated substrate is between about 5 mm and about 50 mm, between about 5 mm and about 40 mm, between about 5 mm and about 30 mm, between about 5 mm and about 20 mm, between about 5 mm and about 10 mm, between about 10 mm and about 50 mm, between about 10 mm and about 40 mm, between about 10 mm and about 30 mm, or between about 10 mm and about 20 mm. By zone coating the substrate, particular washcoat formulations can be applied to particular zones of the substrate in a particular combination to achieve a certain result.

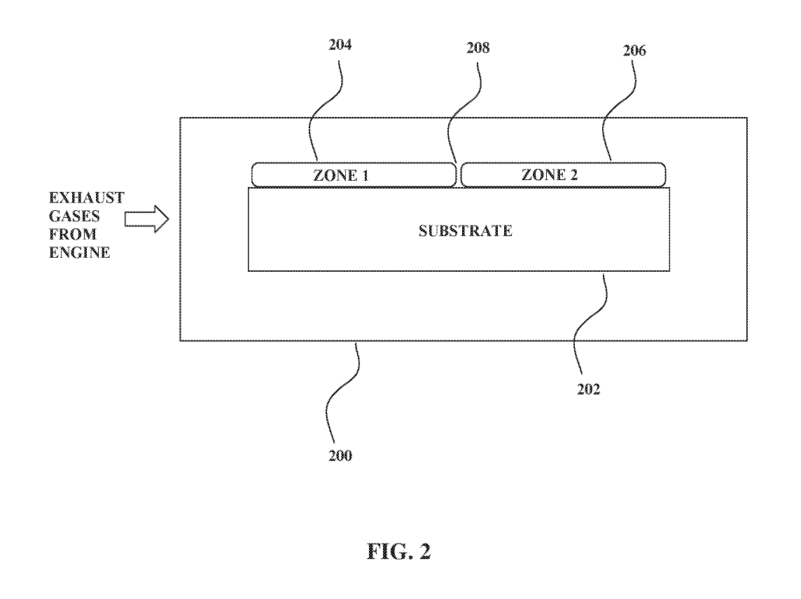

A highly schematic drawing of a zoned catalytic converter is shown in FIG. 2. The coated substrate is contained in a housing (200). A first washcoat is applied in Zone 1 (204) of the substrate (202); a second washcoat is applied in Zone 2 (206) of the substrate (202). The gap between zones (208), which is not washcoated, is minimized. The direction of flow of exhaust gases from the engine is indicated by the arrow. It should be noted that the washcoats are coated on the surface of the interior channels of the substrate; the highly schematic drawing of FIG. 2 is simply meant to aid in conceptualizing the separation of the different washcoats in the different zones, and is not meant to be a detailed physical representation, nor are the dimensions drawn to scale.

In any of the above embodiments, the ratio of the length of the first zone on the substrate to the length of the second zone on the substrate varies between about 3:1 to about 1:3, such as between about 2:1 to about 1:2. By way of illustration, when the ratio of the length of the first zone to the length of the second zone is about 3:1, the first zone takes up about the first 75% of the length of the substrate, while the second zone takes up about the following 25% of the length of the substrate, with a small gap in between the zones as discussed above. In one embodiment, the length of the first zone on the coated substrate is equal to, or about equal to, the length of the second zone on the coated substrate, that is, the first and second zones each occupy about half of the length of the coated substrate, and the ratio of the length of the first zone to the length of the second zone is about 1:1. Since the zones occupy a volume of the substrate proportional to their length, the ratio of the length of the first zone on the substrate to the length of the second zone on the substrate will be the same, or about the same, as the ratio of the volume occupied by the first zone on the substrate to the volume occupied by the second zone on the substrate.

When the zones are of unequal length, the concentrations of ingredients in the various washcoat layers are adjusted so that the same absolute amount of material is present in a given zone, regardless of how much of the substrate the zone occupies. For example, if the first zone contains about 4 g/L of palladium when it occupies 1 liter of space on a substrate, it should contain 6 g/L of palladium when it occupies two-thirds of a liter of space on the substrate, so that the final loading of palladium remains at an absolute amount of 4 grams.

### Washcoat Formulations for First Zone of Catalytic Converters

The first zone (zone 1) of the catalytic converters is described herein. By “first zone” is meant that this is the first zone of the catalytic converter substrate encountered by the engine exhaust gases when the substrate is used in a catalytic converter.

In one embodiment of the washcoat applied to the first zone (“embodiment 1A”), the washcoat comprises metal oxide particles impregnated with barium oxide. Metal oxides which can be used are typically cerium-containing metal oxides, including cerium oxide and composite oxides of cerium with one or more oxides of zirconium, lanthanum and/or yttrium. The cerium-containing metal oxide can be in the form of particles. The cerium-containing metal oxide particles are preferably micron-sized. The cerium-containing metal oxide particles can have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns. A preferred cerium-containing metal oxide is cerium-zirconium-lanthanum oxide (86% by weight ceria, 10% by weight zirconia, 4 percent by weight lanthana), which is commercially available from Rhodia.

Prior to further use, the cerium-containing metal oxide particles can be aged by heating. The particles can be aged at temperatures between about 600° C. to about 1100° C., or between about 700° C. to 1050° C., or about 800° C. to about 1000° C., or about 900° C. to about 1000° C., or at about 980° C., for times between about 2 hours and about 48 hours, between about 4 hours and about 24 hours, between about 6 hours and about 16 hours, between about 8 hours and about 12 hours, or for about 10 hours. In one embodiment, the cerium-containing metal oxide particles are aged for about 10 hours at 980° C.

The cerium-containing metal oxide particles are then impregnated with barium oxide by use of a barium oxide precursor, typically by impregnation with an aqueous solution of a barium salt, followed by drying and calcining. Barium oxide precursors which can be used include barium acetate. The cerium-containing metal oxide particles can be impregnated or loaded to contain about 5% to about 30% barium oxide, or about 8% to about 28% barium oxide, or about 12% to about 24% barium oxide, or about 15% to about 20% barium oxide, or about 18% barium oxide. The cerium-containing metal oxide particles can be impregnated to the point of incipient wetness with an aqueous solution of the barium oxide precursor, followed by drying and calcination of the particles, resulting in barium oxide-impregnated cerium-containing metal oxide particles. The impregnation, drying, and calcining steps can be repeated as necessary, for example, repeated one, two, three, four, five, six, seven, or eight times, to arrive at the desired loading of barium oxide. Drying of the precursor-laden particles can be carried out at a temperature between room temperature and below the boiling point of water, such as between about 25° C. and about 95° C., or about 40° C. to about 80° C., or about 55° C. to about 65° C., such as about 60° C. Drying is performed until further drying results in no further weight loss of the particles, which indicates that the aqueous solvent has been removed. Drying can be carried out for about one hour to seven days, or about two hours to about 48 hours, or about 4 hours to about 24 hours; typically, the higher the temperature, the shorter the drying period. Drying can be carried out for about 12 hours to about 20 hours at about 55° C. to about 65° C., such as for about 16 hours at about 60° C. After drying the precursor-laden support, calcination can be performed. Calcining the dried particles can be performed at a temperature between about 400° C. and about 700° C., or between about 500° C. and 600° C., or between about 525° C. and 575° C., or at about 550° C. Calcining the dried particles can be performed for a time between about 30 minutes and about 12 hours, or about 30 minutes and about 6 hours, or about 1 hour and about 3 hours, or about 2 hours. Calcining the dried particles can be performed at a temperature of about 550° C. for about 2 hours.

Nano-palladium on nano-alumina particles (Pd-alumina NN particles) can then be added to the barium oxide-impregnated cerium-containing metal oxide particles. Synthesis of such composite nanoparticles is described elsewhere in this disclosure. The Pd-alumina NN particles can comprise about 10% to about 70% by weight of palladium and about 90% to about 30% by weight of alumina; about 20% to about 60% by weight of palladium and about 80% to about 40% by weight of alumina; about 30% to about 50% by weight of palladium and about 70% to about 50% by weight of alumina; about 35% to about 50% by weight of palladium and about 65% to about 50% by weight of alumina; or about 30% to about 45% by weight of palladium and about 70% to about 55% by weight of alumina. In one embodiment, the nano-palladium/nano-alumina particles comprise about 40% by weight of palladium and about 60% by weight of alumina. The NN particles are added in an aqueous dispersion to the barium oxide-impregnated cerium-containing metal oxide particles, until the point of incipient wetness, and are then dried and calcined to form nano-palladium on nano-alumina on micro-barium oxide-impregnated cerium-containing metal oxide particles, or nano-on-nano-on-micro (NNm) particles. An amount of NN particles impregnated into the barium oxide-impregnated cerium-containing metal oxide particles is used such that the weight of palladium comprises about 0.1% to about 4% by weight of the final NNm particles, or about 0.5% to about 3.5% by weight of the final NNm particles, or about 1% to about 3% by weight of the final NNm particles, or about 1.5% to about 2.5% by weight of the final NNm particles, or about 1.5% to about 2.0% by weight of the final NNm particles, or about 1.75% to about 2.25% by weight of the final NNm particles, or about 2% to about 2.5% by weight of the final NNm particles. In one embodiment, an amount of NN particles impregnated into the micron-sized particles is used such that the weight of palladium comprises about 2% by weight of the final NNm particles.

These nano-palladium on nano-alumina on micro-barium oxide-impregnated cerium-containing metal oxide particles (NNm particles) can then be mixed into a washcoat formulation. Typically, they are mixed in aqueous solution with boehmite. The solids content of the washcoat formulation comprises about 90% to about 98% by weight of the NNm particles and about 10% to 2% by weight of boehmite; typically, the solids content of the washcoat formulation comprises about 95% of the NNm particles and about 5% boehmite particles. Rheology modifiers and dispersants are added into the washcoat formulation. This washcoat formulation can be used to coat the first zone of the catalytic converters. The washcoat thickness used for the first zone of the substrate can be about 100 g/L to about 340 g/L, or about 150 g/L to about 300 g/L, or about 175 g/L to about 250 g/L, or about 200 g/L to about 240 g/L, or about 150 g/L to about 200 g/L, or about 200 g/L to about 250 g/L, or about 250 g/L to about 300 g/L, or about 250 g/L to about 300 g/L, or about 210 g/L to about 230 g/L, or about 220 g/L.

In an alternate embodiment (“embodiment 1HL”) for the washcoat formulation for the first zone (zone 1), the elements in the embodiment listed above for the washcoat formulation can be used for coating zone 1 of the substrate, but without prior impregnation of the Pd-alumina nano-on-nano particles into the barium oxide-containing micron-sized CZLaO particles. That is, the nano-palladium-on-nano-alumina NN particles can be added as one component to the washcoat, while the micron-sized barium oxide-impregnated cerium-containing metal oxide particles can be added as a separate component, without calcining them together into NNm particles.

In this “half-loose” washcoat formulation, barium oxide-impregnated cerium-containing metal oxide particles, Pd-alumina NN particles in an aqueous dispersion, and boehmite are added to water. The components are mixed. Optionally, the mixture can be ball-milled to reduce particle size. Rheology modifiers, including, but not limited to, corn starch and cellulose are added to adjust the washcoat formulation to the desired viscosity. The “half-loose” washcoat formulation is coated onto zone 1 of the substrate, which is then dried and calcined on the substrate.

In this “half-loose” washcoat formulation, with NN palladium-alumina particles combined with barium oxide-impregnated cerium-containing metal oxide particles, an amount of barium oxide-impregnated cerium-containing metal oxide particles and NN particles is used such that the amount of the weight of palladium in the NN particles comprises about 0.1% to about 4% by weight of the barium oxide-impregnated cerium-containing metal oxide particles, or about 0.5% to about 3.5% by weight of the barium oxide-impregnated cerium-containing metal oxide particles, or about 1% to about 3% by weight of the barium oxide-impregnated cerium-containing metal oxide particles, or about 1.5% to about 2.5% by weight of the barium oxide-impregnated cerium-containing metal oxide particles, or about 1.5% to about 2.0% by weight of the barium oxide-impregnated cerium-containing metal oxide particles, or about 1.75% to about 2.25% by weight of the barium oxide-impregnated cerium-containing metal oxide particles, or about 2% to about 2.5% by weight of the barium oxide-impregnated cerium-containing metal oxide particles. In one embodiment, an amount of NN particles and barium oxide-impregnated cerium-containing metal oxide particles is used such that the weight of palladium comprises about 2% by weight of the barium oxide-impregnated cerium-containing metal oxide particles.

These nano-palladium on nano-alumina particles (NN particles) and micron-sized barium oxide-impregnated cerium-containing metal oxide particles can then be mixed into a washcoat formulation. Typically, they are mixed in aqueous solution with boehmite. The solids content of the washcoat formulation comprises about 90% to about 98% by weight of the NN particles and micron-sized particles, and about 10% to 2% by weight of boehmite; typically, the solids content of the washcoat formulation comprises about 95% of the NN particles and micron-sized particles, and about 5% boehmite particles. Rheology modifiers and dispersants are added into the washcoat formulation. This washcoat formulation can be used to coat the first zone of the catalytic converters. The washcoat thickness used for the first zone of the substrate can be about 100 g/L to about 340 g/L, or about 150 g/L to about 300 g/L, or about 175 g/L to about 250 g/L, or about 200 g/L to about 240 g/L, or about 150 g/L to about 200 g/L, or about 200 g/L to about 250 g/L, or about 250 g/L to about 300 g/L, or about 250 g/L to about 300 g/L, or about 210 g/L to about 230 g/L, or about 220 g/L.

In yet another alternate embodiment (“embodiment 1L”) for the washcoat formulation for the first zone (zone 1), the elements in the embodiment listed above for the washcoat formulation can be used for coating zone 1 of the substrate, but without prior impregnation of the barium oxide into the micron-sized cerium-containing metal oxide particles, and without prior impregnation of the Pd-alumina nano-on-nano particles into the micron-sized CZLaO particles. That is, the nano-palladium-on-nano-alumina NN particles can be added as one component to the washcoat formulation, the micron-sized cerium-containing metal oxide particles can be added as a separate component to the washcoat formulation, and a barium oxide precursor can be added as another separate component to the washcoat formulation.

In this “loose” washcoat formulation, cerium-containing metal oxide particles, Pd-alumina NN particles in an aqueous dispersion, a barium oxide precursor, and boehmite are added to water. The components are mixed. Optionally, the mixture can be ball-milled to reduce particle size. Rheology modifiers, including, but not limited to, corn starch and cellulose are added to adjust the washcoat formulation to the desired viscosity. The “loose” washcoat formulation is coated onto zone 1 of the substrate, which is then dried and calcined on the substrate.

In this “loose” washcoat formulation, with NN palladium-alumina particles combined with cerium-containing metal oxide particles and a barium oxide precursor, an amount of barium oxide precursor is used such that the weight of the final amount of resulting barium oxide is about 5% to about 40% of the weight of the initial cerium-containing metal oxide particles added to the formulation, or about 10% to about 30%, or about 15% to about 25%, or about 18% to about 25%, or about 20% to about 24%, or about 22% of the weight of the initial cerium-containing metal oxide particles added to the formulation. An amount of NN particles is used such that the amount of the weight of palladium in the NN particles comprises about 0.1% to about 4% by weight of the final weight of the total weight of barium oxide and cerium-containing metal oxide particles in the resulting washcoat layer prepared from the formulation, or about 0.5% to about 3.5% by weight of the final weight of the total weight of barium oxide and cerium-containing metal oxide particles in the resulting washcoat layer prepared from the formulation, or about 1% to about 3% by weight of the final weight of the total weight of barium oxide and cerium-containing metal oxide particles in the resulting washcoat layer prepared from the formulation, or about 1.5% to about 2.5% by weight of the final weight of the total weight of barium oxide and cerium-containing metal oxide particles in the resulting washcoat layer prepared from the formulation, or about 1.5% to about 2.0% by weight of the final weight of the total weight of barium oxide and cerium-containing metal oxide particles in the resulting washcoat layer prepared from the formulation, or about 1.75% to about 2.25% by weight of the final weight of the total weight of barium oxide and cerium-containing metal oxide particles in the resulting washcoat layer prepared from the formulation, or about 2% to about 2.5% by weight of the final weight of the total weight of barium oxide and cerium-containing metal oxide particles in the resulting washcoat layer prepared from the formulation. In one embodiment, an amount of NN particles, barium oxide precursor, and cerium-containing metal oxide particles is used such that the weight of palladium comprises about 2% by weight of the final weight of the total weight of barium oxide and cerium-containing metal oxide particles in the resulting washcoat layer prepared from the formulation.

The nano-palladium on nano-alumina particles (NN particles) micron-sized cerium-containing metal oxide particles, and barium oxide precursor can then be mixed into a washcoat formulation. Typically, they are mixed in aqueous solution with boehmite. The solids content of the washcoat formulation comprises about 90% to about 98% by weight of the NN particles, barium oxide precursor, and micron-sized particles, and about 10% to 2% by weight of boehmite; typically, the solids content of the washcoat formulation comprises about 95% of the NN particles barium oxide precursor, and micron-sized particles, and about 5% boehmite particles. Rheology modifiers and dispersants are added into the washcoat formulation. This washcoat formulation can be used to coat the first zone of the substrate. The washcoat thickness used for the first zone of the substrate can be about 100 g/L to about 340 g/L, or about 150 g/L to about 300 g/L, or about 175 g/L to about 250 g/L, or about 200 g/L to about 240 g/L, or about 150 g/L to about 200 g/L, or about 200 g/L to about 250 g/L, or about 250 g/L to about 300 g/L, or about 250 g/L to about 300 g/L, or about 210 g/L to about 230 g/L, or about 220 g/L.

### Washcoat Formulations for Second Zone of Catalytic Converters

Washcoat formulations for the second zone (zone 2) of the substrates for use in catalytic converters are described herein. When the substrate is used in a catalytic converter, the exhaust gases from the engine have already passed through the first zone before encountering the second zone of the catalytic converter substrate. The second zone washcoat formulation is applied to the substrate in a manner so as to deposit the second zone as close as possible to, but not overlapping with, the first zone; preferably, the gap between the end of the first zone and the beginning of the second zone on the substrate is about 5 millimeters, or less than 5 millimeters.

In one embodiment of the washcoat applied to the second zone (“embodiment 2A”), the washcoat comprises nano-palladium particles on nano-ceria particles (Pd-ceria NN particles) on micron-sized oxygen storage material particles, such as the cerium oxide-impregnated alumina oxygen storage material particles described herein. The Pd-ceria NN particles can comprise about 5% to about 65% by weight of palladium and about 95% to about 35% by weight of ceria; about 15% to about 55% by weight of palladium and about 85% to about 45% by weight of ceria; about 15% to about 45% by weight of palladium and about 85% to about 55% by weight of ceria; about 20% to about 40% by weight of palladium and about 80% to about 60% by weight of ceria; or about 25% to about 35% by weight of palladium and about 75% to about 65% by weight of ceria. In one embodiment, the nano-palladium/nano-ceria particles comprise about 30% by weight of palladium and about 70% by weight of ceria.

The Pd-ceria NN particles can be impregnated via incipient wetness onto the micron-sized oxygen storage material particles, such as the cerium oxide-impregnated alumina oxygen storage material particles described herein, followed by drying and calcining to produce nano-on-nano-on-micro (NNm) particles. An amount of NN particles impregnated into the micron-sized particles is used such that the weight of palladium comprises about 0.1% to about 1.5% by weight of the final NNm particles, or about 0.1% to about 0.7% by weight of the final NNm particles, or about 0.5% to about 1% by weight of the final NNm particles, or about 1% to about 1.5% by weight of the final NNm particles, or about 0.1% to about 1.3% by weight of the final NNm particles, or about 0.1% to about 1.1% by weight of the final NNm particles, or about 0.2% to about 1% by weight of the final NNm particles, or about 0.3% to about 0.9% by weight of the final NNm particles, or about 0.4% to about 0.8% by weight of the final NNm particles, or about 0.5% to about 0.7% by weight of the final NNm particles. In one embodiment, an amount of NN particles impregnated into the micron-sized particles is used such that the weight of palladium comprises about 0.6% by weight of the final NNm particles.

These NNm particles are then mixed into a washcoat formulation with boehmite. The solids content of the washcoat formulation comprises about 90% to about 98% by weight of the NNm particles and about 10% to 2% by weight of boehmite; typically, the solids content of the washcoat formulation comprises about 95% of the NNm particles and about 5% boehmite particles. This washcoat formulation can be used to coat the second zone of the substrate. The washcoat thickness used for the second zone of the substrate can be about 100 g/L to about 300 g/L, or about 125 g/L to about 275 g/L, or about 150 g/L to about 250 g/L, or about 175 g/L to about 225 g/L, or about 100 g/L to about 150 g/L, or about 150 g/L to about 200 g/L, or about 200 g/L to about 250 g/L, or about 250 g/L to about 300 g/L, or about 185 g/L to about 215 g/L, or about 200 g/L.

In an alternate embodiment (“embodiment 2L”) for the washcoat formulation for the second zone (zone 2), the elements in the embodiment listed above for the washcoat formulation can be used for coating zone 2 of the substrate, but without prior impregnation of the Pd-ceria nano-on-nano (NN) particles onto the micron-sized oxygen storage material particles, such as the cerium oxide-impregnated alumina oxygen storage material particles described herein. In this “loose” washcoat formulation, micron-sized oxygen storage material particles, Pd-ceria NN particles in an aqueous dispersion, and boehmite are added to water. The components are mixed. Optionally, the mixture can be ball-milled to reduce particle size. Rheology modifiers, including, but not limited to, corn starch and cellulose are added to adjust the washcoat formulation to the desired viscosity. The “loose” washcoat formulation is coated onto zone 2 of the substrate, which is then dried and calcined on the substrate.

The Pd-ceria NN particles in the “loose” washcoat formulation can comprise about 5% to about 65% by weight of palladium and about 95% to about 35% by weight of ceria; about 15% to about 55% by weight of palladium and about 85% to about 45% by weight of ceria; about 15% to about 45% by weight of palladium and about 85% to about 55% by weight of ceria; about 20% to about 40% by weight of palladium and about 80% to about 60% by weight of ceria; or about 25% to about 35% by weight of palladium and about 75% to about 65% by weight of ceria. In one embodiment, the nano-palladium/nano-ceria particles comprise about 30% by weight of palladium and about 70% by weight of ceria.

In the “loose” washcoat formulation, with NN palladium-ceria particles combined with oxygen storage particles, an amount of oxygen storage material particles and NN particles is used such that the amount of the weight of platinum in the NN particles used is about 0.1% to about 0.7% of the weight of the oxygen storage material particles used, or about 0.5% to about 1% of the weight of the oxygen storage material particles used, or about 1% to about 1.5% of the weight of the oxygen storage material particles used, or about 0.1% to about 1.3% of the weight of the oxygen storage material particles used, or about 0.1% to about 1.1% of the weight of the oxygen storage material particles used, or about 0.2% to about 1% of the weight of the oxygen storage material particles used, or about 0.3% to about 0.9% of the weight of the oxygen storage material particles used, or about 0.4% to about 0.8% of the weight of the oxygen storage material particles used, or about 0.5% to about 0.7% of the weight of the oxygen storage material particles used. In one embodiment, the amount of the weight of platinum in the NN particles is about 0.6% of the weight of the oxygen storage material particles used.

The NN particles and oxygen storage material particles are then mixed into a washcoat formulation with boehmite. The solids content of the “loose” washcoat formulation comprises about 90% to about 98% by weight of the NN particles and oxygen storage material particles and about 10% to 2% by weight of boehmite; typically, the solids content of the washcoat formulation comprises about 95% of the NN particles and oxygen storage material particles, and about 5% boehmite particles. This “loose” washcoat formulation can be used to coat the second zone of the substrate. The washcoat thickness used to coat the second zone can be about 100 g/L to about 300 g/L, or about 125 g/L to about 275 g/L, or about 150 g/L to about 250 g/L, or about 175 g/L to about 225 g/L, or about 100 g/L to about 150 g/L, or about 150 g/L to about 200 g/L, or about 200 g/L to about 250 g/L, or about 250 g/L to about 300 g/L, or about 185 g/L to about 215 g/L, or about 200 g/L.

### Addition of Rhodium to Second Zone of Substrate

In certain embodiments, rhodium can be optionally added to the second zone of the substrate. The substrates of the invention and catalytic converters of the invention can be rhodium-free as discussed herein; however, rhodium can be added for certain applications or conditions when desired.

Rhodium is added by using a solution of a rhodium salt to impregnate the micron-sized oxygen storage material particles, such as the cerium oxide-impregnated alumina oxygen storage material particles described herein, followed by drying and calcining (and reductive treatment, if necessary) to convert the rhodium salt into rhodium metal. Rhodium trichloride, rhodium trichloride hydrate, rhodium acetate, rhodium nitrate, and other rhodium salts known in the art can be used to prepare the solution of rhodium salts for wet-chemistry impregnation of the oxygen storage material particles.

When rhodium is used, it is added in an amount from about 0.01 g/L to about 0.6 g/L, or from about 0.01 g/L to about 0.5 g/L, or from about 0.01 g/L to about 0.4 g/L, or from about 0.01 g/L to about 0.3 g/L, or from about 0.01 g/L to about 0.2 g/L, or from about 0.01 g/L to about 0.1 g/L, or from about 0.05 g/L to about 0.6 g/L, or from about 0.05 g/L to about 0.5 g/L, or from about 0.05 g/L to about 0.4 g/L, or from about 0.05 g/L to about 0.3 g/L, or from about 0.05 g/L to about 0.2 g/L, or from about 0.05 g/L to about 0.1 g/L, or from about 0.1 g/L to about 0.6 g/L, or from about 0.1 g/L to about 0.5 g/L, or from about 0.1 g/L to about 0.4 g/L, or from about 0.1 g/L to about 0.3 g/L, or from about 0.1 g/L to about 0.2 g/L, or from about 0.15 g/L to about 0.45 g/L, or from about 0.2 g/L to about 0.4 g/L, or from about 0.25 g/L to about 0.35 g/L, or about 0.3 g/L; the amounts given are for when the length of the second zone is roughly equal to the length of the first zone (i.e., the second zone occupies roughly half of the substrate). In other embodiments when rhodium is used, it is added in an amount of no more than about 0.6 g/L, or no more than about 0.5 g/L, or no more than about 0.4 g/L, or no more than about 0.3 g/L, or no more than about 0.2 g/L, or no more than about 0.1 g/L, or no more than about 0.05 g/L, or no more than about 0.01 g/L; the amounts given are for when the length of the second zone is roughly equal to the length of the first zone (i.e., the second zone occupies roughly half of the substrate). A typical loading of rhodium in the second zone of the substrate is about 0.25 g/L to about 0.35 g/L, such as about 0.3 g/L. (The amount of 0.3 g/L refers to the coverage in the volume of the second zone when the second zone occupies about half of the substrate, thus, were the amount of rhodium to be calculated over the volume of both zones of the substrate, the amount would be 0.15 g/L).

Rhodium can be added to the oxygen storage material particles in either the “2A” embodiment or the “loose” “2L” embodiment described above. The 2A embodiment with rhodium can be designated as “2A+R,” and the “2L” embodiment with rhodium can be designated as “2L+R.”

### Zone Combinations

The washcoats described above can be used on the substrate as follows: 1A for the first zone, and 2A for the second zone; 1HL for the first zone, and 2A for the second zone; 1L for the first zone, and 2A for the second zone; 1A for the first zone, and 2L for the second zone; 1HL for the first zone, and 2L for the second zone; 1L for the first zone, and 2L for the second zone. When rhodium is added, the washcoats described above can be used on the substrate as follows: 1A for the first zone, and 2A+R for the second zone; 1HL for the first zone, and 2A+R for the second zone; 1L for the first zone, and 2A+R for the second zone; 1A for the first zone, and 2L+R for the second zone; 1HL for the first zone, and 2L+R for the second zone; 1L for the first zone, and 2L+R for the second zone.

It should be noted that the washcoat formulations can be coated onto the substrate in any order. That is, the first washcoat formulation can be coated onto the first zone, followed by coating the second washcoat formulation onto the second zone; or the second washcoat formulation can be coated onto the second zone, followed by coating the first washcoat formulation onto the first zone. The substrate can be calcined after the initial washcoating of one of the zones onto the substrate, followed by washcoating the remaining zone onto the substrate and a second calcination of the substrate; or, where possible, both zones can be washcoated onto the substrate prior to calcination of the substrate.

### Plasma Synthesis of Nano-on-Nano Particles

The composite nano-particles described herein may be formed by plasma reactor methods, by feeding one or more catalytic materials, such as one or more platinum group metal(s), and one or more support materials, such as a metal oxide, into a plasma gun, where the materials are vaporized. Plasma guns such as those disclosed in US 2011/0143041, the disclosure of which is hereby incorporated by reference in its entirety, can be used, and techniques such as those disclosed in U.S. Pat. No. 5,989,648, U.S. Pat. No. 6,689,192, U.S. Pat. No. 6,755,886, and US 2005/0233380, the entire disclosures of which are hereby incorporated by reference herein, can be used to generate plasma. The high-throughput system disclosed in U.S. Published Patent Application No. 2014/0263190 and International Patent Application No. PCT/US2014/024933 (published as WO 2014/159736), the entire disclosures of which are hereby incorporated by reference herein, can be used to generate the composite nanoparticles. A working gas, such as argon, is supplied to the plasma gun for the generation of plasma; in one embodiment, an argon/hydrogen mixture (for example, in the ratio of 10:1 Ar/H₂ or 10:2 Ar/H₂) is used as the working gas. In one embodiment, one or more platinum group metals, such as platinum or palladium, which are generally in the form of metal particles of about 0.5 to 6 microns in diameter, can be introduced into the plasma reactor as a fluidized powder in a carrier gas stream such as argon. In some embodiments two or more platinum group metals may be added, such as a mixture of platinum and palladium in any ratio, or any range of ratios. Support material, for example a metal oxide, such as aluminum oxide or cerium oxide, or mixtures of two or more of cerium oxide, zirconium oxide, lanthanum oxide, or yttrium oxide in any proportion, in a particle size of about 15 to 25 microns diameter, is also introduced as a fluidized powder in carrier gas. In some embodiments, a composition of about 10 wt % to about 65 wt % platinum group metal(s) and about 90 wt % to about 35 wt % metal oxide may be used, and even more preferably a composition of about 30 wt % to about 40 wt % platinum group metal(s) and about 70 wt % to about 60 wt % metal oxide may be used.

Other methods of introducing the materials into the reactor can be used, such as in a liquid slurry. Any solid or liquid materials are rapidly vaporized or turned into plasma. The kinetic energy of the superheated material, which can reach temperatures of 20,000 to 30,000 Kelvin, ensures extremely thorough mixing of all components.

The superheated material of the plasma stream is then quenched rapidly, using such methods as the turbulent quench chamber disclosed in US 2008/0277267. Argon quench gas at high flow rates, such as 2400 to 2600 liters per minute, is injected into the superheated material. The material is further cooled in a cool-down tube, and collected and analyzed to ensure proper size ranges of material. Equipment suitable for plasma synthesis is disclosed in U.S. Patent Application Publication No. 2008/0277267, U.S. Pat. No. 8,663,571, U.S. patent application Ser. No. 14/207,087 and International Patent Appl. No. PCT/US2014/024933. As the mixed platinum group metal(s)-support material plasma cools down, composite nano-particles comprising a platinum group metal nanoparticle bonded to a support nanoparticle form. If two or more platinum group metals were introduced into the plasma gun, along with the support material, then composite nanoparticles, comprising a nanoparticle comprising an alloy of those platinum group metals bonded to a support nanoparticle, form.

The plasma production method described above produces highly uniform composite nano-particles, where the composite nano-particles comprise a catalytic nano-particle bonded to a support nano-particle.

### Exhaust Systems, Vehicles, and Emissions Performance

In some embodiments of the invention, a coated substrate as disclosed herein is housed within a catalytic converter in a position configured to receive exhaust gas from an internal combustion engine, such as in an exhaust system of an internal combustion engine, for example a gasoline engine. The catalytic converter can be installed on a vehicle containing a gasoline engine. The catalytic converter can treat gases from a stationary engine.

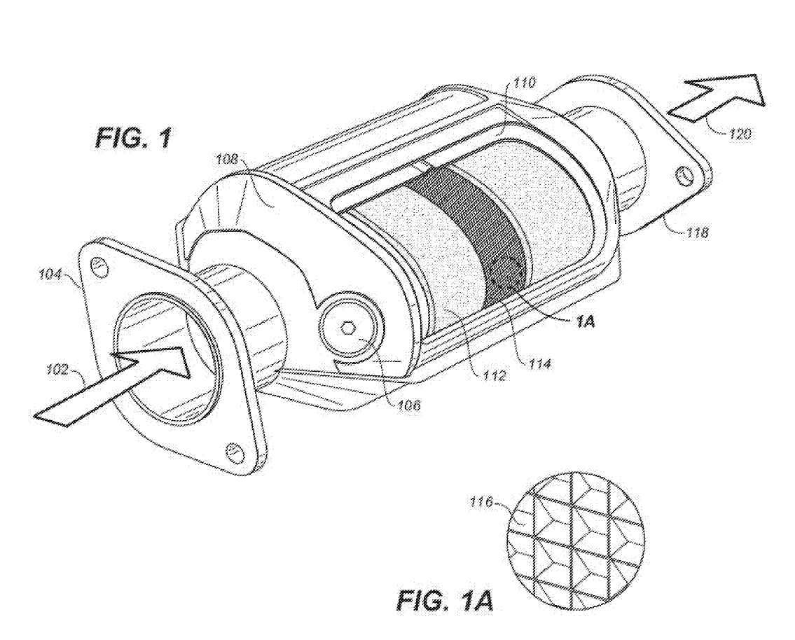

The coated substrate is placed into a housing, such as that shown in FIG. 1, which can in turn be placed into an exhaust system (also referred to as an exhaust treatment system) of an internal combustion engine. The internal combustion engine can be a gasoline engine. The exhaust system of the internal combustion engine receives exhaust gases from the engine, typically into an exhaust manifold, and delivers the exhaust gases to an exhaust treatment system. The catalytic converter forms part of the exhaust system. The exhaust system can also include other components, such as oxygen sensors, HEGO (heated exhaust gas oxygen) sensors, UEGO (universal exhaust gas oxygen) sensors, sensors for other gases, and temperature sensors. The exhaust system can also include a controller such as an engine control unit (ECU), a microprocessor, or an engine management computer, which can adjust various parameters in the vehicle (fuel flow rate, fuel/air ratio, fuel injection, engine timing, valve timing, etc.) in order to optimize the components of the exhaust gases that reach the exhaust treatment system, so as to manage the emissions released into the environment.

“Treating” an exhaust gas, such as the exhaust gas from a gasoline engine, refers to having the exhaust gas proceed through an exhaust system (exhaust treatment system) prior to release into the environment, in order to reduce the amount of harmful gases, such as unburned hydrocarbons, carbon monoxide, or nitrogen oxides present in the exhaust gas.

The coated substrates, catalytic converters, and exhaust systems described herein can be employed in vehicles which use a gasoline engine. The coated substrates, catalytic converters, and exhaust systems described herein can be employed to treat gases from a stationary gasoline engine.

### Performance Characteristics of Catalytic Converters

In one embodiment, a vehicle equipped with a catalytic converter utilizing a substrate of the invention meets the United States Environmental Protection Agency Tier 2 Exhaust Emission Standards.

In one embodiment, a vehicle equipped with a catalytic converter utilizing a substrate of the invention meets the United States Environmental Protection Agency Tier 3 Exhaust Emission Standards.

In one embodiment, a vehicle equipped with a catalytic converter utilizing a substrate of the invention meets the Euro 5 pollution standards.

In one embodiment, a vehicle equipped with a catalytic converter utilizing a substrate of the invention meets the Euro 6 pollution standards.

### EXAMPLES

The invention is further illustrated by the following examples.

### Example 1

### Oxygen Storage Material

2250 grams of cerium chloride heptahydrate (from Alfa Aesar) were dissolved in 2000 grams water. The pH of the resulting solution was about 0.5. The solution was added to 3400 grams of micron-sized aluminum oxide particles stabilized with lanthanum (MI-386, Rhodia). The aluminum oxide particles had been previously aged at 980° C. for 10 hours under ambient atmosphere. The cerium chloride solution was added to the alumina particles until the point of incipient wetness. The cerium chloride-loaded alumina particles were dried at 60° C. for 16 hours, then calcined for two hours at 550° C., to produce the cerium oxide-impregnated alumina particles for use as oxygen storage materials.

### Example 2

### Zoned Catalytic Converter for Treatment of Gasoline Engine Exhaust

### Washcoat Formulation for Zone 1 Using Nano-on-Nano-on-Micro (NNm) Particles

Cerium-zirconium-lanthanum oxide particles (CZLaO) were purchased from Rhodia (86% by weight ceria, 10% by weight zirconia, 4% by weight lanthana). The particles were aged at 980° C. for 10 hours under ambient atmosphere. 90 grams of barium acetate was dissolved in 157 grams of water, and added to 1000 grams of the aged CZLaO particles to the point of incipient wetness. The particles were dried at 60° C. for 16 hours, and then calcined at 550° C. for 2 hours. This impregnation-drying calcining procedure with barium acetate was repeated three times (thus, the CZLaO particles were impregnated with barium acetate solution, dried, and calcined a total of four times). The resulting CZLaO powder contained 18% barium oxide.

A dispersion in water containing 10% by weight of solids was prepared, using water and nano-on-nano palladium-on-alumina particles (the nano-on-nano particles were 40% by weight of Pd, 60% by weight of Al₂O₃). This dispersion was added to barium oxide-impregnated CZLaO powder to the point of incipient wetness; the powder was then dried and calcined to produce nano-on-nano-on-micro (NNm) powders (nano-palladium on nano-alumina on micro-CZLaO, where the micro-CZLaO microparticles had been impregnated with barium oxide. The final palladium loading on the NNm powder was 2% by weight.

An aqueous washcoat formulation was made using 95% by weight of the nano-palladium on nano-alumina on barium oxide-impregnated micro-CZLaO and 5% boehmite, and rheology modifiers. This washcoat formulation was used to coat a first zone of a substrate to a thickness of 220 g/L.

### “Loose” Formulation for Zone 1

61 grams of deionized water were placed in a container. 20.6 grams of solid barium acetate were added, and the mixture stirred until the barium acetate dissolved. 33.6 grams of a dispersion of nano-palladium on nano-alumina (the nano-on-nano particles comprised 40% by weight Pd, 60% by weight Al₂O₃) were added; the dispersion contained 10% solids by weight and was at pH 4. 57 grams of aged cerium-zirconium-lanthanum oxide (CZLaO) particles were added. Finally, 3.57 grams of boehmite were added. Rheology modifiers were added and the pH adjusted to 4. This washcoat formulation was coated onto a first zone of a cordierite substrate, dried, and calcined for a resulting thickness of 220 g/L.

### Washcoat Formulation for Zone 2 Using Nano-on-Nano-on-Micro (NNm) Particles

A dispersion in water containing 5% by weight of solids was prepared, using water and nano-on-nano palladium-on-ceria particles (the nano-on-nano particles were 30% by weight of Pd, 70% by weight of cerium oxide); the pH of the dispersion was about 4. This dispersion was impregnated into the cerium oxide-containing oxygen storage material particles as prepared in Example 1. The particles were dried at 60° C., and then calcined for 2 hours at 550° C. to yield nano-on-nano-on-micro particles. The final loading of palladium on the nano-on-nano-on-micro particles was 0.6% by weight. A washcoat suspension was prepared, with a solids content of 95% by weight of the nano-on-nano-on-micro particles and 5% by weight of boehmite. The resulting washcoat formulation was applied to a second zone of a cordierite substrate, dried, and calcined. The washcoat thickness was approximately 200 g/L.

### “Loose” Formulation for Zone 2

90 grams of deionized water were placed in a container. 10 grams (about 10 mL) of a 10% by weight dispersion of nano-palladium on nano-ceria composite particles (nano-on-nano Pd-ceria, or NN Pd-ceria) were added. 47.5 grams of cerium oxide-containing oxygen storage material particles as prepared in Example 1 were added. 3.6 grams of boehmite were added. The mixture was balled-milled, and rheology modifiers were added. The resulting washcoat formulation was applied to a second zone of a cordierite substrate, dried, and calcined. The washcoat thickness was approximately 200 g/L.

The disclosures of all publications, patents, patent applications and published patent applications referred to herein by an identifying citation are hereby incorporated herein by reference in their entirety. Web sites references using “World-Wide-Web” at the beginning of the Uniform Resource Locator (URL) can be accessed by replacing “World-Wide-Web” with “www.”

Although the foregoing invention has been described in some detail by way of illustration and example for purposes of clarity of understanding, it is apparent to those skilled in the art that certain changes and modifications will be practiced. Therefore, the description and examples should not be construed as limiting the scope of the invention.

1. A coated substrate for use in a catalytic converter for treatment of gasoline engine exhaust, comprising:
a) a substrate;
b) a first washcoat layer disposed in a first zone of the substrate, the first washcoat layer comprising:
b.i) first composite nanoparticles comprising a first catalytic nanoparticle bonded to a first support nanoparticle; and
either b.ii) first metal oxide particles impregnated with barium oxide, or b.ii′) first metal oxide particles and barium oxide;
c) a second washcoat layer disposed in a second zone of the substrate, the second washcoat layer comprising:
c.i) second composite nanoparticles comprising a second catalytic nanoparticle bonded to a second support nanoparticle; and
c.ii) oxygen storage particles;
wherein the first zone and second zone on the substrate do not overlap.

2-5. (canceled)

6. The coated substrate of claim 1, wherein the first catalytic nanoparticle of the first composite nanoparticles comprises palladium.

7. The coated substrate of claim 1, wherein the first support nanoparticle of the first composite nanoparticles comprises aluminum oxide.

8. The coated substrate of claim 1, wherein the first metal oxide particles comprise a metal oxide selected from the group consisting of cerium oxide, cerium-zirconium oxide, cerium-zirconium-lanthanum oxide, cerium-zirconium-yttrium oxide, and cerium-zirconium-lanthanum-yttrium oxide, said first metal oxide particles further impregnated with barium oxide.

9. The coated substrate of claim 1, wherein the first metal oxide particles comprise cerium-zirconium-lanthanum oxide, said cerium-zirconium-lanthanum oxide further impregnated with barium oxide.

10. The coated substrate of claim 1, wherein the second catalytic nanoparticle of the second composite nanoparticles comprises palladium.

11. The coated substrate of claim 1, wherein the second support nanoparticle of the second composite nanoparticles comprises a metal oxide selected from the group consisting of cerium oxide, cerium-zirconium oxide, cerium-zirconium-lanthanum oxide, cerium-zirconium-yttrium oxide, and cerium-zirconium-lanthanum-yttrium oxide.

12. The coated substrate of claim 1, wherein the oxygen storage material particles comprise a second metal oxide impregnated with a third metal oxide.

13. The coated substrate of claim 12, wherein the second metal oxide is selected from the group consisting of aluminum oxide and aluminum oxide stabilized with lanthanum.

14. The coated substrate of claim 12, wherein the third metal oxide is selected from the group consisting of cerium oxide, cerium-zirconium oxide, cerium-zirconium-lanthanum oxide, cerium-zirconium-yttrium oxide, and cerium-zirconium-lanthanum-yttrium oxide.

15. The coated substrate of claim 12, wherein the second metal oxide comprises aluminum oxide stabilized with lanthanum, and the third metal oxide comprises cerium oxide.

16. The coated substrate of claim 1, wherein the first metal oxide particles are between about 500 nm and about 10 microns in diameter.

17. The coated substrate of claim 1, wherein the oxygen storage particles are between about 500 nm and about 10 microns in diameter.

18. The coated substrate of claim 1, wherein the substrate is a cordierite substrate.

19. The coated substrate of claim 1, wherein the coated substrate is substantially free of rhodium.

20. The coated substrate of claim 1, wherein the oxygen storage particles further comprise rhodium.

21. The coated substrate of claim 20, wherein the rhodium is present in the second zone of the substrate in an amount between about 0.05 g/L and about 0.5 g/L.

22. The coated substrate of claim 1, wherein the coated substrate is substantially free of platinum.

23-42. (canceled)

43. A method of making a coated substrate for use in a catalytic converter for treatment of gasoline engine exhaust, comprising:
coating a substrate with a first washcoat formulation in a first zone of the substrate, the first washcoat formulation comprising first composite nanoparticles comprising a first catalytic nanoparticle bonded to a first support nanoparticle; and first metal oxide particles impregnated with barium oxide or a barium oxide precursor;
coating the substrate with a second washcoat formulation in a second zone of the substrate, the second washcoat formulation comprising second composite nanoparticles comprising a second catalytic nanoparticle bonded to a second support nanoparticle; and oxygen storage particles;
wherein the first zone and second zone on the substrate do not overlap.

44-86. (canceled)

87. A coated substrate prepared by the method of claim 43.

88. A catalytic converter comprising a coated substrate of claim 1.

89. A method of treating exhaust gases from a gasoline engine with the catalytic converter of claim 88, comprising passing the exhaust gases through the catalytic converter, wherein the exhaust from the gasoline engine contacts the first zone of the coated substrate in the catalytic converter prior to contacting the second zone of the substrate.

90. A vehicle comprising the catalytic converter of claim 88.

91. (canceled)

92. A gasoline-powered generator comprising the catalytic converter of claim 88.

93-116. (canceled)
